(19) United States
(12) Patent Application Publication
(10) Pub. No.: US 2017/0306990 A1
(43) Pub. Date: Oct. 26, 2017

(54) ENERGY SAVING DIRECTIONAL-CONTROL VALVES FOR PROVIDING INPUT-OUTPUT COMPATIBILITY WITH STANDARD NON-ENERGY SAVING DIRECTIONAL-CONTROL VALVES

(71) Applicant: Nexmatix LLC, St. Louis, MO (US)

(72) Inventor: Michael Goldfarb, Franklin, TN (US)

(73) Assignee: Nexmatix LLC, St. Louis, MO (US)

(21) Appl. No.: 15/516,086

(22) PCT Filed: Oct. 3, 2015
(86) PCT No.: PCT/US15/53890

§ 371 Date: Mar. 31, 2017

Related U.S. Application Data
(60) Provisional application No. 62/059,486, filed on Oct. 3, 2014.

(51) Int. Cl. F15B 13/02; F15B 13/043; F15B 13/04; F15B 13/00

(52) U.S. Cl. CPC F15B 13/021; F15B 13/043; F15B 13/0402; F15B 2013/041; F15B 2013/0412; F15B 2013/006

(57) ABSTRACT

An energy saving directional-control valves (2-position and 3-position) are configured with standard manual override functionality and with the same steady-state input-output behavior as each respective standard/non-energy saving directional-control valve. This allows a standard non-energy saving valve to be replaced with an energy saving valve without reconfiguring the external electrical and manual override command logic.

### CROSS-REFERENCE TO RELATED APPLICATIONS

This application claims priority to U.S. Provisional Patent Application Ser. No. 62/059,486, filed Oct. 3, 2014, which is currently pending.

### STATEMENT REGARDING FEDERALLY SPONSORED RESEARCH OR DEVELOPMENT

Not Applicable.

### APPENDIX

Not Applicable.

### BACKGROUND OF THE INVENTION

### Field of the Invention

This application relates generally to pneumatic directional control valves. More specifically, the present invention is directed to apparatus and methods for configuring and operating energy-saving directional-control valves having manual override functionality in a manner such that said directional-control valves have full input-output compatibility/interchangeability with standard (i.e., non-energy-saving) 2 and 3-position directional-control valves.

### General Background

A “standard” 2 or 3-position directional-control valve is defined for purposes of this disclosure as one that selectively connects four or more fluid ports in two or three port-to-port connectivity configurations, respectively. The four ports are referred to herein as supply (operatively connected to a source of pressurized fluid), exhaust (typically operatively connected to the atmosphere or a low pressure line), first outlet (operatively connected to one side of pneumatic actuator), and second outlet (operatively connected to the other side of the pneumatic actuator). A standard 2-position directional-control valve will selectively allow either a first port-to-port connectivity configuration in which supply is connected to the first outlet port, and exhaust connected to the second outlet port, or a second port-to-port connectivity configuration in which supply is connected to the second outlet port, and exhaust connected to the first outlet port. A standard 2-position valve can further be classified as a monostable or bistable type of valve, where the former reverts to the first port-to-port connectivity configuration when control power to the valve is removed, while the latter maintains the last commanded port-to-port connectivity configuration when power to the valve is removed.

A standard 3-position directional-control valve provides the first and second port-to-port connectivity of a 2-position valve, and additionally provides a third port-to-port connectivity when power is removed from the valve. The third port-to-port connectivity (associated with power down) is typically one of three types: one in which all ports are blocked; one in which the supply port is blocked, and the first and second outlet ports are connected to exhaust; and one in which the exhaust port is blocked, and the first and second outlet ports are connected to supply. As such, there are five basic variants or types of standard directional-control valves, as follows: a 2-position monostable valve (hereinafter “2P-MST”), which reverts to the first port-to-port connectivity configuration when power is removed; a 2-position bistable valve (hereinafter “2P-BST”), which maintains current connectivity when power is removed; a 3-position valve that reverts to all ports blocked when power is removed (hereinafter “3P-APB”); a 3-position valve that connects outlet ports to exhaust when power is removed (hereinafter “3P-EC”); and a 3-position valve that connects outlet ports to supply when power is removed (3 P-SC).

The port-to-port connectivity is generally selected in these directional-control valves via an electrical command input to the valve. For the case of a 2P-MST valve, there is one electrical command input, which is a voltage input that can be regarded as a logical command to the valve. A logical 1 (or high) command configures the valve in the second port-to-port connectivity configuration, while a logical 0 (or low) command configures the valve in the first port-to-port connectivity configuration. For the case of the other four valve types, the electrical input consists of two logical input commands. For a 2P-BST, the logical pair (1,0) configures the valve in the first port-to-port connectivity configuration; the logical pair (0,1) configures the valve in the second port-to-port connectivity configuration; the logical pair (0,0) maintains the current configuration; and the configuration for the logical pair (1,1) is not defined (i.e., it is not used). For any of the 3-position valves, the logical pair (1,0) configures the valve in the first port-to-port connectivity configuration; the logical pair (0,1) configures the valve in the second port-to-port connectivity configuration; the logical pair (0,0) configures the valve in the third port-to-port connectivity configuration; and the configuration for the logical pair (1,1) is not used.

In addition to normal electrical commands, a standard valve can also be configured to respond to a manual override command (hereinafter “MO”). In the case of a 2P-MST, a single MO exists, which when activated, will configure the valve into the second port-to-port connectivity configuration, and when not activated, maintains the valve current port-to-port configuration of the valve. For the case of the other four valve types, there are two MOs. Considering the MOs as (manual) logical inputs, and in the absence of electrical input, the valve behavior in response to the MO input is similar to its behavior in response to electrical input. Specifically, for a 2P-BST, the MO logical pair (1,0) configures the valve in the first port-to-port connectivity configuration; the MO logical pair (0,1) configures the valve in the second port-to-port connectivity configuration; the MO logical pair (0,0) maintains the current configuration; and the MO logical pair (1,1) is not used. For any of the 3-position valves, the MO logical pair (1,0) configures the valve in the first port-to-port connectivity configuration; the MO logical pair (0,1) configures the valve in the second port-to-port connectivity configuration; the MO logical pair (0,0) maintains current configuration; and the MO logical pair (1,1) is not used. The collective behavior of the valve will be the result of a logical OR operation between the electrical and MO commands.

In some cases, it is desirable to add an additional port-to-port connectivity configuration to a standard directional-control valve. Specifically, when switching between the first port-to-port connectivity configuration and the second port-to-port connectivity configuration, for example, if the first and second outlet ports are connected while the supply and exhaust ports are blocked, the valve will allow compressed air to flow from the previously pressurized outlet port to the previously depressurized outlet port, which effectively recycles some mass of compressed air prior to exhausting it. A valve with this additional port-to-port connectivity is referred to here as an “energy-saving” valve, since it can recycle compressed air when switching between the first and second port-to-port connectivity configurations, and therefore a system controlled by an energy-saving valve will require less new compressed air to move an actuator from a configuration associated with the first port-to-port connectivity configuration to a configuration associated with the second. Such valves are described in U.S. Pat. No. 8,635,940, PCT/US2013/078430, and PCT/US2013/078433, which are hereby incorporated herein by reference in their entireties.

The addition of an energy-saving port-to-port connectivity configuration to the standard directional-control valve configurations results in three port-connectivity configurations rather than two, in the case of 2-postion valve types (i.e., 2P-MST or 2P-BST), and four total port-connectivity configurations rather than three, in the case of the 3-position valve types (i.e., 3P-APB, 3P-EC, or 3P-SC).

### SUMMARY OF THE INVENTION

Despite the increment in number of port-to-port connectivity configurations associated with energy saving directional-control valves, the inventor believes that it would be desirable to further configure such energy-saving valves with manual override functionality and with the same steady-state input-output behavior as each respective standard/non-energy saving valve. Doing so allows a standard non-energy saving valve to be replaced with an energy saving valve without reconfiguring the external electrical and manual override command logic. To achieve this, at least one embodiment of an energy-saving valve with manual override for each type of standard valve variant has been developed to have the same steady-state port-to-port connectivity as the standard valve variant. This application describes those valves and the methods by which they operate.

In one aspect of the invention, a pilot-operated directional-control valve comprises a valve body, at least four fluid ports, a valve spool, a first pilot cylinder, a second pilot cylinder, a first biasing member, a second biasing member, a normally-depressurized pilot solenoid valve, and a normally-pressurized pilot solenoid valve. The at least four fluid ports, valve spool, the first pilot cylinder, and the second pilot cylinder are disposed within the valve body. The valve spool moves to a first position when the first pilot cylinder is pressurized and the second pilot cylinder is de-pressurized. The valve spool is moved to a second position when the second pilot cylinder is pressurized and the first pilot cylinder is de-pressurized. The valve spool moves to a third position by the first and second biasing members when the first and second pilot cylinders are de-pressurized. The normally-depressurized pilot solenoid controls pressure to the first pilot cylinder. The normally-pressurized pilot solenoid controls the pressure to the second pilot cylinder and the first pilot cylinder. And the first diameter and the second pilot cylinder has a second diameter and second diameter is smaller than the first diameter.

In another aspect of the invention, a pilot-operated directional-control valve comprises a valve body, at least four fluid ports, a valve spool, a first pilot cylinder, a second pilot cylinder, a first biasing member, a second biasing member, a normally-depressurized pilot solenoid valve, a normally-pressurized pilot solenoid valve, a shuttle valve comprising first and second inlet ports and an outlet port, and a spring-return pilot-operated 3-way valve. The at least four fluid ports, the valve spool, the first pilot cylinder, the second pilot cylinder, the shuttle valve, and the spring-return pilot-operated 3-way valve are disposed within the valve body. The valve spool moves to a first position when the first pilot cylinder is pressurized and the second pilot cylinder is de-pressurized. The valve spool moves to a second position when the second pilot cylinder is pressurized and the first pilot cylinder is de-pressurized. The valve spool moves to a third position by the first and second biasing members when the first and second pilot cylinders are de-pressurized. The outlet port of the shuttle valve supplies pilot pressure to the spring-return pilot-operated 3-way valve. The spring-return pilot-operated 3-way valve pressurizes the second pilot cylinder when de-energized and de-pressurizes the second pilot cylinder when energized. The normally-depressurized pilot solenoid controls the pressure to the first pilot cylinder and to the first inlet port of the shuttle valve. And the normally-pressurized pilot solenoid valve controls the pressure to the second inlet port of the shuttle valve.

In yet another aspect of the invention, a pilot-operated directional-control valve comprises a valve body, at least four fluid ports including a first outlet port and a second outlet port, a valve spool, a first pilot cylinder, a second pilot cylinder, a first biasing member, a second biasing member, a first normally-depressurized pilot solenoid valve, a second normally-depressurized pilot solenoid valve, a third normally-depressurized pilot solenoid valve, and a spring-return pilot-operated 2-way valve comprising a pilot port. The at least four fluid ports, the valve spool, the first pilot cylinder, the second pilot cylinder, the shuttle valve, and the spring-return pilot-operated 2-way valve are disposed within the valve body. The valve spool moves to a first position when the first pilot cylinder is pressurized and the second pilot cylinder is de-pressurized. The valve spool moves to a second position when the second pilot cylinder is pressurized and the first pilot cylinder is de-pressurized. The valve spool moves to a third position by the first and second biasing members when the first and second pilot cylinders are de-pressurized. The spring-return pilot-operated 2-way valve controls fluid communication between the first outlet port and the second outlet port, such that the first outlet port and the second outlet port are in fluid communication when the spring-return pilot-operated 2-way valve is energized. The first outlet port and the second outlet port are not in fluid communication when the spring-return pilot-operated 2-way valve is de-energized. The first normally-depressurized pilot solenoid valve controls pressure to the first pilot cylinder. The second normally-depressurized pilot solenoid valve controls pressure to the second pilot cylinder. And the third normally-depressurized pilot solenoid valve controls pressure to the pilot port of the spring-return pilot-operated 2-way valve.

In still another aspect of the invention, a pilot-operated directional-control valve comprises a valve body, at least four fluid ports including a first outlet port and an exhaust port, a valve spool, a first pilot cylinder, a second pilot cylinder, a first biasing member, a second biasing member, a first normally-depressurized pilot solenoid valve, a second normally-de-pressurized pilot solenoid valve, a third normally-depressurized pilot solenoid valve, a spring-return pilot-operated 2-way valve, and a shuttle valve having a first inlet port, a second inlet port, and an outlet port. The at least four fluid ports, the valve spool, the first pilot cylinder, the second pilot cylinder, the shuttle valve, and the spring-return pilot-operated 2-way valve are disposed within the valve body. The valve spool moves to a first position when the first pilot cylinder is pressurized and the second pilot cylinder is de-pressurized. The valve spool moves to a second position when the second pilot cylinder is pressurized and the first pilot cylinder is de-pressurized. The valve spool moves to a third position by the first and second biasing members when the first and second pilot cylinders are depressurized. The outlet port of the shuttle valve supplies pilot pressure to the spring-return pilot-operated 2-way valve. The spring-return pilot-operated 2-way valve controls fluid communication between the first outlet port and the exhaust port, such that the first outlet port and the exhaust port are not in fluid communication when the spring-return pilot-operated 2-way valve is energized, and the first outlet port and the exhaust port are in fluid communication when the spring-return pilot-operated 2-way valve is de-energized. The first normally-depressurized pilot solenoid valve controls pressure to the first pilot cylinder and to the first inlet port of the shuttle valve. The second normally-depressurized pilot solenoid valve controls pressure to the second pilot cylinder. And the third pilot solenoid valve controls pressure to the second inlet port of the shuttle valve.

In another aspect of the invention, a pilot-operated directional-control valve comprises a valve body, at least four fluid ports including a first outlet port and a supply port, a valve spool, a first pilot cylinder, a second pilot cylinder, a first biasing member, a second biasing member, a first normally-depressurized pilot solenoid valve, a second normally-depressurized pilot solenoid valve, a third normally-depressurized pilot solenoid valve, a shuttle valve comprising a first inlet port, a second inlet port, an outlet port, and a spring-return pilot-operated 2-way valve. The at least four fluid ports, the valve spool, the first pilot cylinder, the second pilot cylinder, the shuttle valve, and the spring-return pilot-operated 2-way valve are disposed within the valve body. The valve spool moves to a first position when the first pilot cylinder is pressurized and the second pilot cylinder is de-pressurized. The valve spool moves to a second position when the second pilot cylinder is pressurized and the first pilot cylinder is de-pressurized. The valve spool moves to a third position by the first and second biasing members when the first and second pilot cylinders are depressurized. The outlet port of the shuttle valve supplies pilot pressure to the spring-return pilot-operated 2-way valve. The spring-return pilot-operated 2-way valve controls fluid communication between the first outlet port and the supply port, such that the first outlet port and the supply port are not in fluid communication when the spring-return pilot-operated 2-way valve is energized, and the first outlet port and the supply port are in fluid communication when the spring-return pilot-operated 2-way valve is de-energized. The second normally-depressurized pilot solenoid valve controls pressure to the second pilot cylinder and to the second inlet port of the shuttle valve. And the third normally-depressurized pilot solenoid valve controls pressure to the first inlet port of the shuttle valve.

In yet another aspect of the invention, a pilot-operated directional-control valve comprises a valve body, at least four fluid ports including an exhaust port, a valve spool, a first pilot cylinder, a second pilot cylinder, a first biasing member, a second biasing member, a first normally-depressurized pilot solenoid valve, a second normally-depressurized pilot solenoid valve, a third normally-pressurized pilot solenoid valve, a first 3-way valve comprising a first pilot port and a second pilot port, and a second 3-way valve comprising a first pilot port and a second pilot port. The at least four fluid ports, the valve spool, the first pilot cylinder, the second pilot cylinder, the shuttle valve, the first 3-way valve and the second 3-way valve are disposed within the valve body. The valve spool moves to a first position when the first pilot cylinder is pressurized and the second pilot cylinder is de-pressurized. The valve spool moves to a second position when the second pilot cylinder is pressurized and the first pilot cylinder is de-pressurized. The valve spool moves to a third position by the first and second biasing members when the first and second pilot cylinders are depressurized. The first pilot solenoid valve is configured to control pressure to the first pilot port of the first 3-way valve and the second pilot port of the second 3-way valve. The second pilot solenoid valve is configured to control pressure to the second pilot port of the first 3-way valve and the first pilot port of the second 3-way valve. The first 3-way valve is configured to couple the first pilot cylinder to either an outlet of the third normally-pressurized solenoid pilot valve or exhaust. The second 3-way valve couples the second pilot cylinder to either an outlet of the third normally-pressurized solenoid pilot valve or the exhaust port.

In yet another aspect of the invention, a pilot-operated directional-control valve comprises a valve body, at least four fluid ports, a valve spool, a first pilot cylinder, a second pilot cylinder, a first biasing member, a second biasing member, a first normally-depressurized pilot solenoid valve, a second normally-depressurized pilot solenoid valve, a third normally-depressurized pilot solenoid valve, a first shuttle valve comprising a first inlet port and a second inlet port, a single-acting spring return cylinder comprising a piston, and a second shuttle valve comprising a first inlet port and a second inlet port. The at least four fluid ports, the valve spool, the first pilot cylinder, the second pilot cylinder, the first shuttle valve, the second shuttle valve and the single-acting spring return cylinder are disposed within the valve body. The valve spool moves to a first position when the first pilot cylinder is pressurized and the second pilot cylinder is de-pressurized. The valve spool moves to a second position when the second pilot cylinder is pressurized and the first pilot cylinder is de-pressurized. The valve spool moves to a third position by the first and second biasing members when the first and second pilot cylinders are depressurized. The outlet port of the first shuttle valve is configured to supply pressure to the first inlet port of the second shuttle valve. The outlet port of the second shuttle valve is configured to supply pressure to the single-acting cylinder. The first normally-depressurized pilot solenoid valve is configured to control pressure to the first pilot cylinder and configured to control pressure to the first inlet port of the first shuttle valve. The second normally-depressurized pilot solenoid valve is configured to control pressure to the second pilot cylinder and configured to control pressure to the second inlet port of the second shuttle valve. The third normally-depressurized pilot solenoid valve is configured to control pressure to the second inlet port of the first shuttle valve. The spool of the directional-control valve further comprises detents, such that the detents are engaged by the piston of the single-acting cylinder when the single-acting cylinder is energized.

Further features and advantages of the present invention, as well as the operation of the invention, are described in detail below with reference to the accompanying drawings.

### BRIEF DESCRIPTION OF THE DRAWINGS

FIG. 1 depicts a first embodiment of a valve in accordance with the invention and shows the valve in an energized state with the spool moved to a position to the right.

FIG. 2 depicts the first valve embodiment in a de-energized state with its spool moved to a position to the left.

FIG. 3 depicts the first valve embodiment in an intermediate dwell state with its spool moved to a center position by the biasing members (e.g. centering springs) located on each end of the spool.

FIG. 4 depicts the first valve embodiment in a manual override state with its spool moved to the position to the right.

FIG. 5 depicts a second embodiment of a valve in accordance with the invention and shows the valve in an energized state with its spool moved to a position to the right.

FIG. 6 depicts the second valve embodiment in a de-energized state with its spool moved to a position to the left.

FIG. 7 depicts the second valve embodiment in an intermediate dwell state with its spool moved to a center position by biasing members.

FIG. 8 depicts the second valve embodiment in a manual override state with its spool moved to the position to the right.

FIG. 9 depicts a third valve embodiment in accordance with the invention in an energized state with its spool moved to a position to the right.

FIG. 10 depicts the third valve embodiment in an energized state with its spool moved to a position to the left.

FIG. 11 depicts the third valve embodiment in an intermediate dwell state with its spool moved to a center position.

FIG. 12 depicts the third valve embodiment in a manual override state with its spool moved to the position to the right.

FIG. 13 depicts the third valve embodiment in a manual override state with its spool moved to the position to the left.

FIG. 14 depicts the third valve embodiment in a de-energized state with its spool moved to a center position.

FIG. 15 depicts a fourth valve embodiment in accordance with the invention in an energized state with its spool moved to a position to the right.

FIG. 16 depicts the fourth valve embodiment n an energized state with its spool moved to a position to the left.

FIG. 17 depicts the fourth valve embodiment in an intermediate dwell state with its spool moved to a center position.

FIG. 18 depicts the fourth valve embodiment in a manual override state with its spool moved to the position to the right.

FIG. 19 depicts the fourth valve embodiment in a manual override state with its spool moved to the position to the left.

FIG. 20 depicts the fourth valve embodiment in a de-energized state with its spool moved to a center position.

FIG. 21 depicts a fifth valve embodiment in accordance with the invention in an energized state with its spool moved to a position to the right.

FIG. 22 depicts the fifth valve embodiment in an energized state with its spool moved to a position to the left.

FIG. 23 depicts the fifth valve embodiment in an intermediate dwell state with its spool moved to a center position.

FIG. 24 depicts the fifth valve embodiment in a manual override state with its spool moved to the position to the right.

FIG. 25 depicts the fifth valve embodiment in a manual override state with its spool moved to the position to the left.

FIG. 26 depicts the fifth valve embodiment in a de-energized state and with its spool moved to a center position.

FIG. 27 depicts a sixth valve embodiment in accordance with the invention with its spool moved to a position to the right in either an energized (e.g., S1 energized) or first manual override state.

FIG. 28 depicts the sixth valve embodiment with its spool moved to a position to the left in either an energized (e.g., S2 energized) or second manual override state.

FIG. 29 depicts the sixth valve embodiment in an intermediate dwell state with its spool moved to a center position.

FIG. 30 depicts the sixth valve embodiment in a de-energized state with its spool moved to a center position.

FIG. 31 depicts the sixth valve embodiment in a de-energized state with its spool moved to a position to the left.

FIG. 32 depicts a seventh valve embodiment in accordance with the invention in an energized state with its spool moved to a position to the right.

FIG. 33 depicts the seventh valve embodiment in an energized state with its spool moved to a position to the left.

FIG. 34 depicts the seventh valve embodiment in an intermediate dwell state with its spool moved to a center position.

FIG. 35 depicts the seventh valve embodiment in a manual override state with its spool moved to the position to the right.

FIG. 36 depicts the seventh valve embodiment in a manual override state with its spool moved to the position to the left.

FIG. 37 depicts the seventh valve embodiment in a de-energized state with its spool moved to a position to the right.

FIG. 38 depicts the seventh valve embodiment in a de-energized state with its spool moved to a position to the left.

FIG. 39 depicts an eighth valve embodiment in accordance with the invention in an energized state with its spool moved to a position to the right.

FIG. 40 depicts the eighth valve embodiment in an energized state with its spool moved to a position to the left.

FIG. 41 depicts the eighth valve embodiment in an intermediate dwell state with its spool moved to a center position.

FIG. 42 depicts the eighth valve embodiment in a manual override state with its spool moved to the position to the right.

FIG. 43 depicts the eighth valve embodiment in a manual override state with its spool moved to the position to the left.

FIG. 44 depicts the eighth valve embodiment in a de-energized state with its spool moved to a center position.

FIG. 45 depicts a ninth valve embodiment in accordance with the invention in an energized state with its spool moved to a position to the right.

FIG. 46 depicts the ninth valve embodiment in an energized state with its spool moved to a position to the left.

FIG. 47 depicts the ninth valve embodiment in an intermediate dwell state with its spool moved to a center position.

FIG. 48 depicts the ninth valve embodiment in a manual override state with its spool moved to the position to the right.

FIG. 49 depicts the ninth valve embodiment in a manual override state with its spool moved to the position to the left.

FIG. 50 depicts the ninth valve embodiment in a de-energized state with its spool moved to a center position.

Reference numerals in the written specification and in the drawing figures indicate corresponding items.

### DETAILED DESCRIPTION

Each of the valve embodiments described below and shown in the drawing figures comprises first and second outlet ports (2, 4) and at least two exhaust ports (3, 5). In use, the outlet ports (2, 4) are connected to opposite sides of one or more pneumatic actuators. In the figures, exhaust outlets are represented by triangles and pressure inlets are indicated by circles. Solenoids are indicated by the letter S and are either normally closed (NC) or normally open (NO) in the absence of power being supplied to them. More specifically, a normally closed (NC) solenoid, which can also be described as a normally depressurized solenoid, depressurizes the respective pilot cylinder when de-energized (S=0 corresponds to a depressurized pilot state), and pressurizes it when energized (S=1 corresponds to a pressurized state). A normally open (NO) solenoid, which can also be described as normally pressurized solenoid, pressurizes the respective pilot cylinder when de-energized (S=0 corresponds to a pressurized state), and depressurizes it when energized (S=1 corresponds to a depressurized state). The logic table shown for each valve embodiment shows how the solenoids are activated in response to the standard electrical or manual override PLC signals provided to the valve. A PLC state of 1 indicates the corresponding solenoid is energized by the PLC, typically in the form of a DC or AC voltage (e.g., 24 volts DC), while a PLC state of 0 indicates the corresponding solenoid is de-energized. The valves do not receive any explicit PLC commands that configure them into the dwell (i.e., energy recovery) position. Instead, the valves are switched to the dwell position briefly by internal valve circuitry for a time period determined by that circuitry when a PLC command changes from a first signal to a second signal (e.g., from 0 to 1, or 1 to 0). Only after the transient dwell period does the valve circuitry configure the valve into the said second state. It is assumed that the manual override signals are received by the valves when the valves are de-energized. In addition to solenoids, each valve comprises a spool valve in a spool valve body that generates the various port-to-port connectivity configurations of the valve. Additionally, some of the valves comprise additional pressure actuated valves. The solenoids and the other pressure actuated valves control the movement of the spool within the spool valve body to control which port-to-port connectivity configuration mode the spool valve is in at any given time.

A total of nine valve configurations are described herein as follows: two configurations for input-output compatibility for a 2P-MST valve variant; one for a 3P-APB valve variant; three for a 3P-EC valve variant; one for a 3P-SC valve variant; and two for a 2P-BST valve variant.

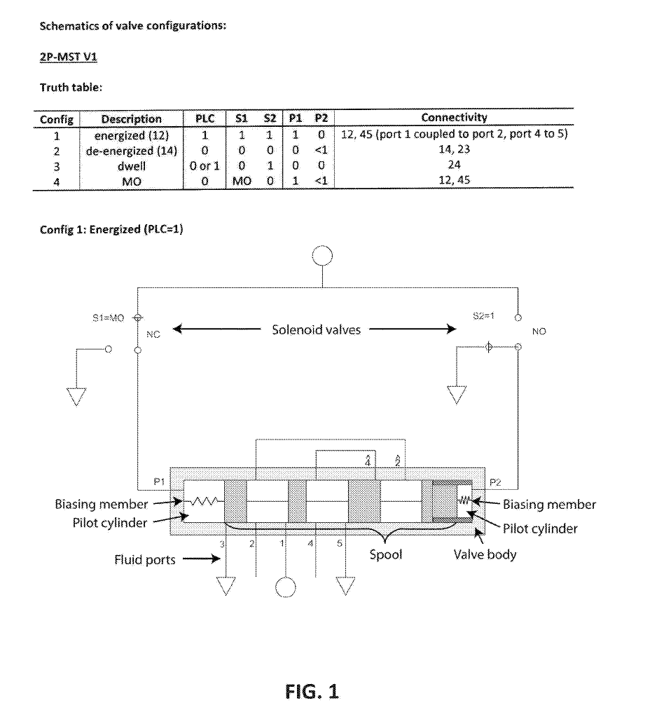

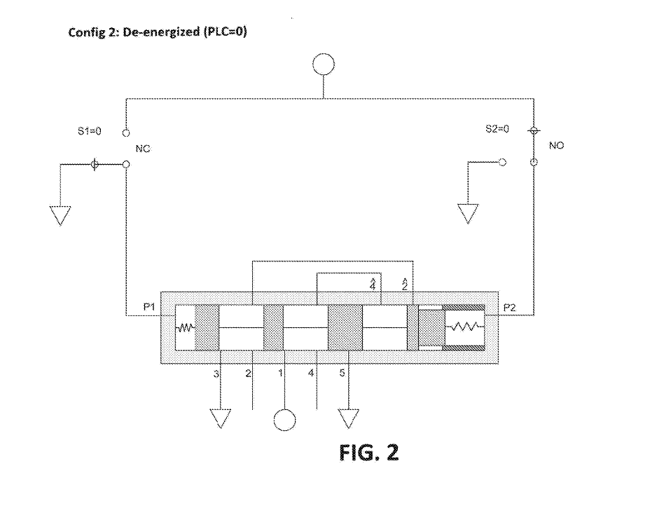

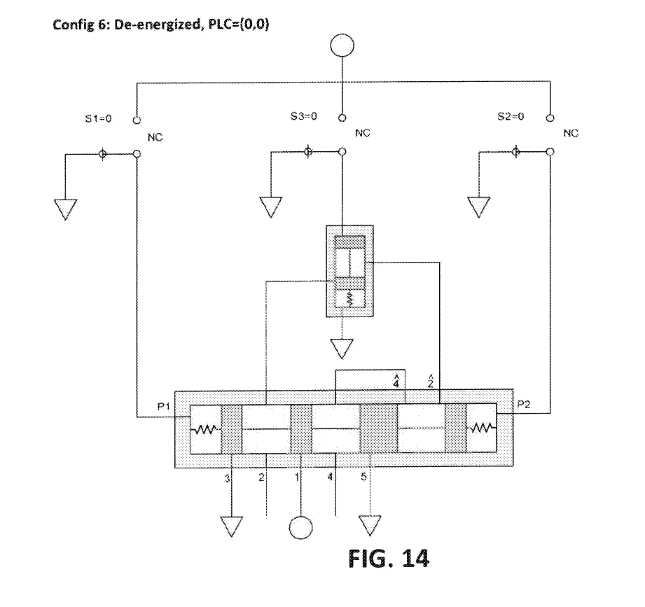

A first 2P-MST configured valve (2P-MST V1) in accordance with the invention is shown in FIG. 14. This first embodiment comprises two solenoids (S1, S2), which are operated by one PLC command, and require override compatibility with one MO input. In the figures, a solenoid state of 1 indicates the respective solenoid is energized, while a solenoid state of 0 indicates the respective solenoid is de-energized. In any given state, the solenoids can be energized or de-energized either by the PLC command, or by the internal valve circuitry. The internal valve circuitry, however, is generally assumed to be powered by the PLC input, so the ability of the internal circuitry to energize the solenoids in the absence of PLC input is limited to short durations (e.g., the duration of the dwell period). A solenoid state of MO indicates the solenoid has been moved to the energized configuration via a manual override input (rather than by an electrical input). In the energized state shown in FIG. 1, corresponding to PLC=1, solenoid S1 and solenoid S2 are both energized by the PLC input. Since S1 is of the NC type and S2 is of the NO type, energizing both corresponds to pressurizing P1 (the leftmost pilot cylinder) and de-pressurizing P2 (the rightmost pilot cylinder). In response, the spool moves to the right as shown and thereby connects outlet 2 to the pressure source 1 and connects outlet port 4 to exhaust port 5. During this time, the spool blocks auxiliary flow channel 4̂, which in turn isolates output ports 2 and 4, and as such, the valve assumes one of the two standard MST port connectivity configurations. When the valve is de-energized (i.e., PLC=0), as shown in FIG. 2, neither solenoid is energized and therefore the NC solenoid S1 de-pressurizes the leftmost pilot cylinder (P1), and the NO solenoid S2 pressurizes the rightmost pilot cylinder (P2).

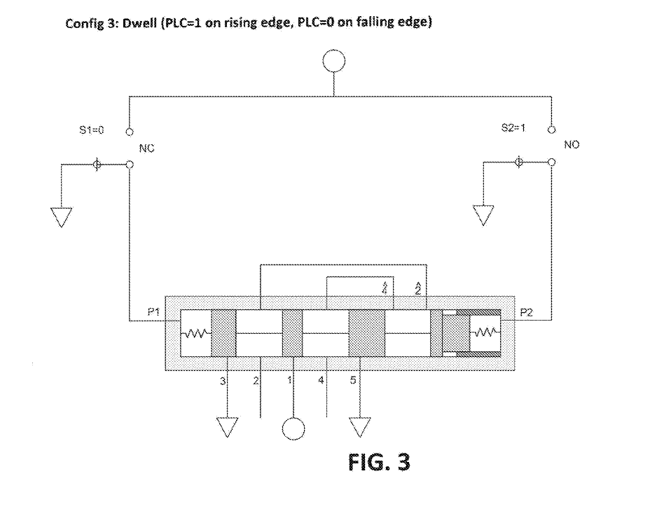

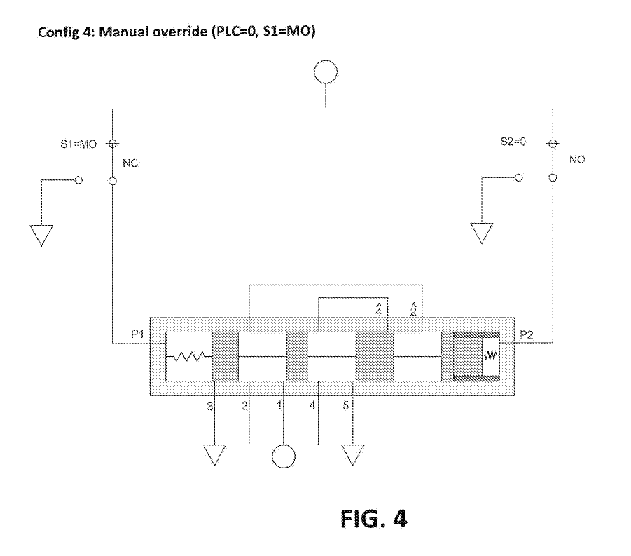

This reverses the pressures acting on the spool, thereby moving the spool to the left as shown. In that position, the spool connects outlet port 2 to exhaust port 3 and the spool piston second from the right blocks auxiliary flow channel 2̂, which in turn isolates outlet ports 2 and 4, and as such, the valve assumes the other of the two standard MST port connectivity configurations. In dwell mode, shown in FIG. 3, solenoid S2 is energized while solenoid S1 is de-energized. Since the solenoids are NO and NC, respectively, this de-pressurizes both pilot cylinders and allows the spool to move to an equilibrium position as determined by the biasing springs of the spool valve. In this spool position, the auxiliary flow channel 4̂ and auxiliary flow channel 2̂ are unblocked by the spool, and therefore operatively connects auxiliary flow channel 4̂ and auxiliary flow channel 2̂ to each other. As such, outlet port 2 is in fluid communication with outlet port 4 when the valve is in dwell mode. Note that when transitioning on a rising edge of the PLC, the internal valve circuitry energizes only solenoid S2 for the brief dwell period, then energizes both solenoid S1 and solenoid S2. When transitioning on a falling edge of the PLC, the internal valve circuitry does the same, but uses energy stored in a capacitor to supply the finite amount of energy required to energize S2 in the absence of PLC input. In manual override mode shown in FIG. 4, solenoid S1 is manually opened (i.e., the output is pressurized) by the manual input, while solenoid S2 remains in its de-energized open state, and as such, both pilot cylinders are pressurized. Notably, however, the rightmost pilot cylinder has a diameter that is smaller than the leftmost pilot cylinder. Preferably the smaller diameter is more than five percent smaller than the larger diameter. More preferably, the smaller diameter is more than ten percent smaller than the larger diameter. Even more preferably, the smaller diameter is more than twenty percent smaller than the larger diameter. Even more preferably, the smaller diameter is more than 30 percent smaller than the larger diameter. The differences in diameters causes the leftmost pilot cylinder to exert more pressure force on the spool than does the rightmost pilot cylinder, and thereby causes the spool to move to the right when both pilot cylinders are pressurized, as when the valve is in the manual override mode. Thus, like with the energized mode, output port 2 is connected to pressure port 1 while output port 4 is connected to exhaust 5 when the valve is in the manual override mode, and outlet port 2 is in fluid isolation from outlet port 4.

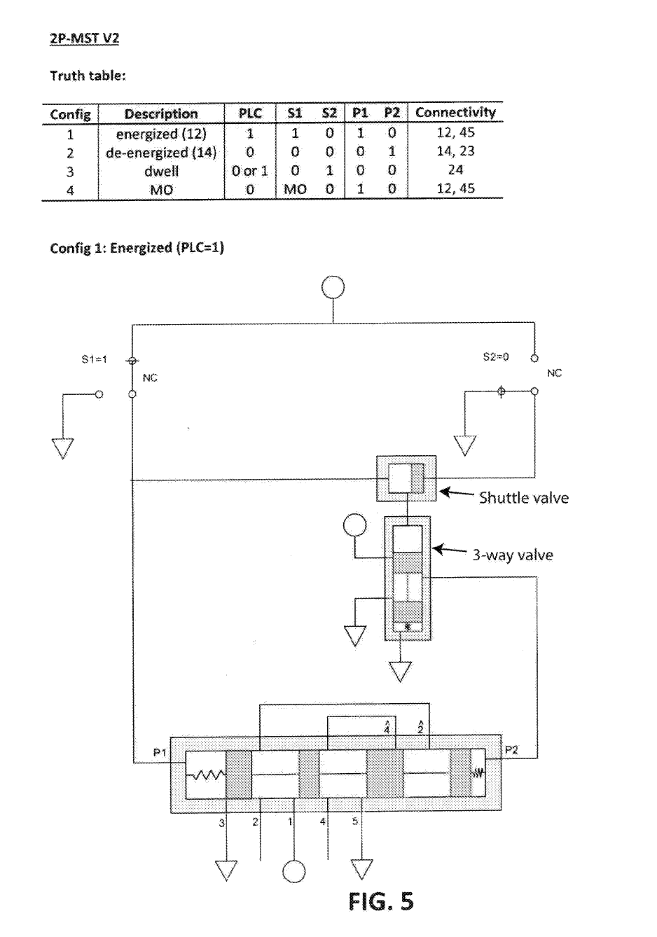

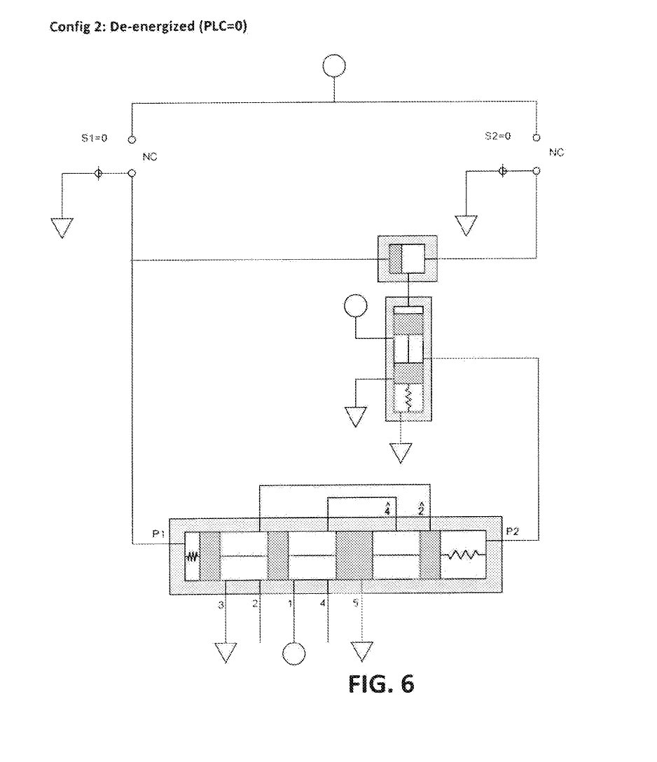

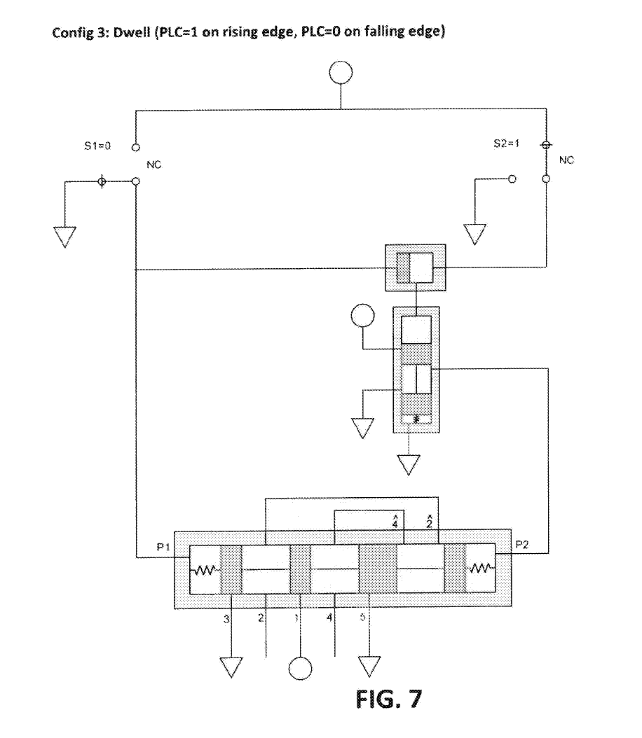

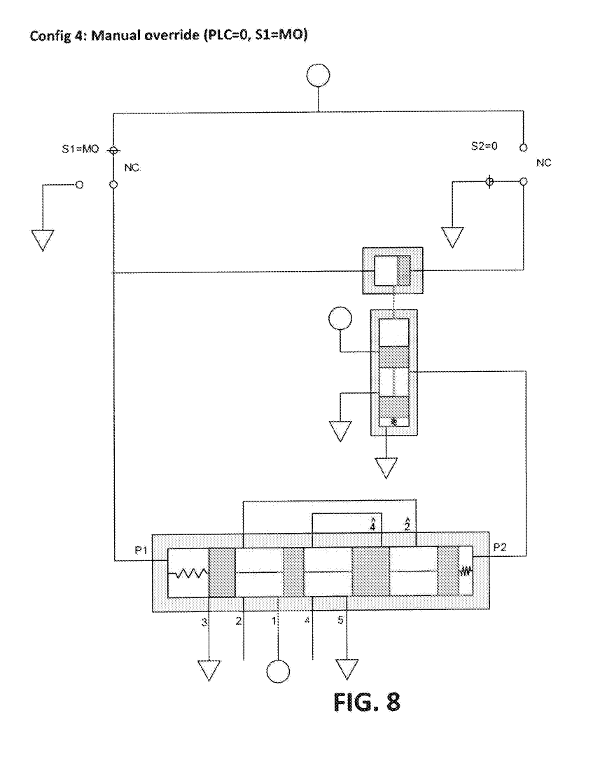

A second 2P-MST configured valve (2P-MST V2) is shown in FIGS. 5-8. In this second valve, the diameters of the pilot cylinders are equal. However, this second valve further comprises a shuttle valve and a spring-return pilot-operated 3-way valve. Solenoids S1 and S2 are both NC (normally de-pressurized) solenoids in this valve embodiment. In the energized state (PLC=1), shown in FIG. 5, solenoid S1 is energized while solenoid S2 is not. This connects the leftmost pilot cylinder to pressure and it also supplies pressure to the left side of the shuttle valve. The opposite side of the shuttle valve is connected to exhaust via solenoid S2 and therefore the shuttle in the shuttle valve moves to the right which pressurizes the top of the spring-return pilot-operated 3-way valve, forcing its control spool downward against its biasing spring. In turn, that connects the rightmost pilot cylinder to exhaust. The pressure differential between the two pilot cylinders thereby causes the spool to move to the right, which connects output port 2 to pressure port 1 and output port 4 to exhaust port 5 (i.e., provides the first standard configuration of port connectivity). When de-energized (PLC=0), as shown in FIG. 6, both solenoids S1, S2 are depressurized, which depressurizes both inputs to the shuttle valve, which allows the control spool of the spring-return pilot-operated 3-way valve to move upward via its biasing spring. Moving the control spool of the spring-return pilot-operated 3-way valve upward connects the rightmost pilot cylinder of the spool valve to the pressure source. Since the leftmost pilot cylinder is depressurized (by virtue of solenoid S1 being de-energized), the pressure differential between the two pilot cylinders thereby causes the spool to move to the left, which connects output port 4 to pressure port 1 and output port 2 to exhaust port 3 (i.e., PLC=0 corresponds to the second MST standard valve configuration). In dwell mode, shown in FIG. 7, solenoid S2 is energized while solenoid S1 is not (using similar valve circuitry described for the 2P-MST V1 valve embodiment). Energizing solenoid S2 connects the shuttle valve to pressure and moves the shuttle therein to the left, and causes pressure to act on the top of the control spool of the spring-return pilot-operated 3-way valve, forcing it downward against its biasing spring and thereby connecting the rightmost pilot cylinder of the spool valve to exhaust. De-energizing solenoid S1 connects the leftmost pilot cylinder to exhaust. As such, no differential pressure acts on the spool of the spool valve and the spool therefore moves to its equilibrium position by the biasing springs of the spool valve. This leaves auxiliary flow channel 4̂ and auxiliary flow channel 2̂ unblocked by the spool and therefore operatively connects auxiliary flow channel 4̂ and auxiliary flow channel 2̂ to each other. As such, outlet port 2 is in communication with outlet port 4 when the valve is in dwell mode. In manual override mode, solenoid S1 is manually activated (i.e., pressurized) while solenoid S2 remains inactivated (i.e., depressurized). This puts the control valve in the same configuration it is in when energized (i.e., PLC=1).

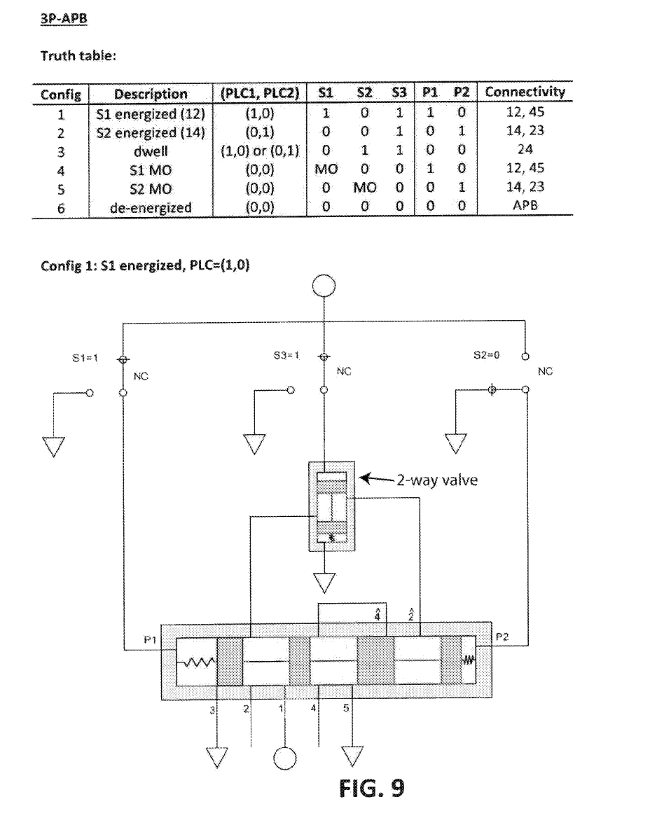

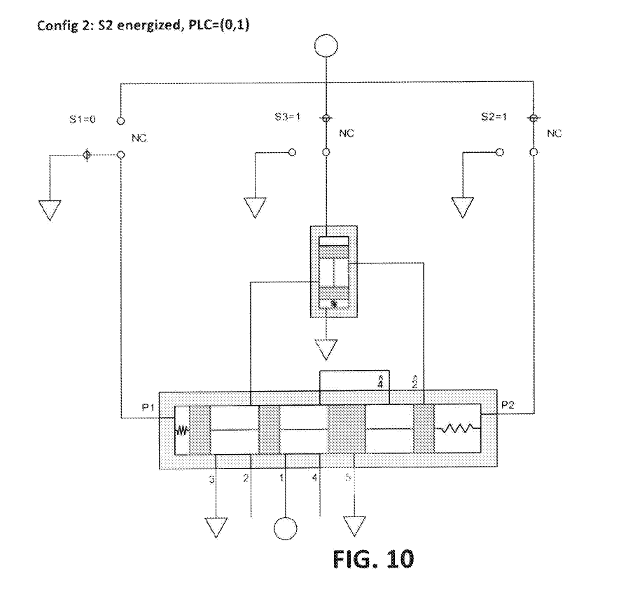

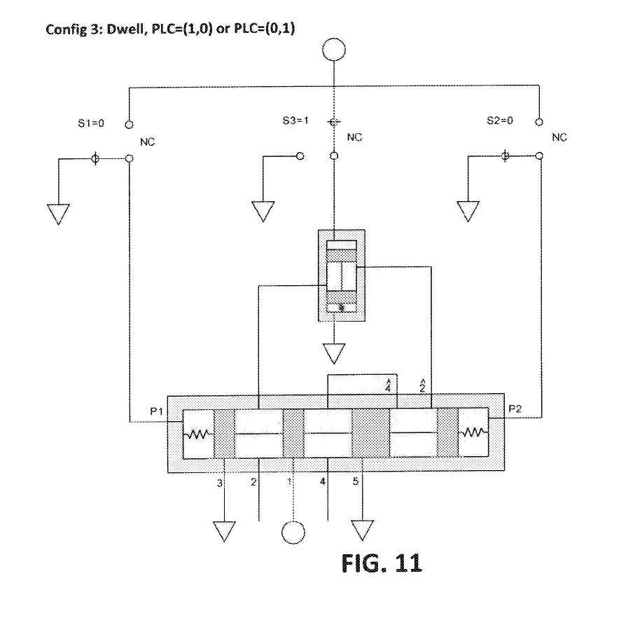

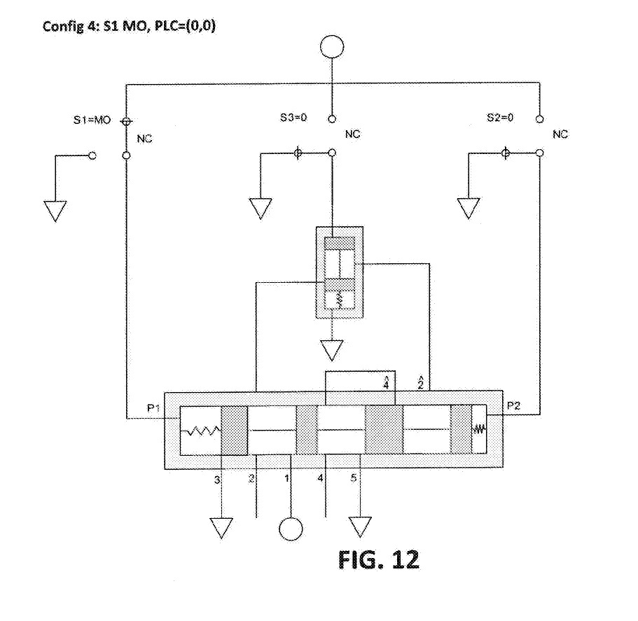

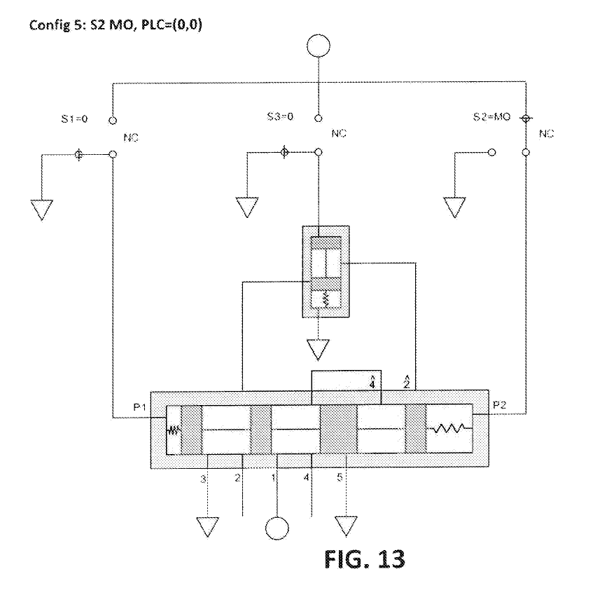

A 3P-APB configured valve is shown in FIGS. 9-14 and comprises three solenoids (S1, S2, and S3), all three of which are normally closed when de-energized. The three solenoids are operated by two PLC commands (PLC1 and PLC2), and require override compatibility with two MO inputs (S1 MO and S2 MO). When the valve is in the standard S1 energized configuration (i.e., PLC1=1, PLC2=0), as shown in FIG. 9, solenoid S1 and S3 are energized (i.e., pressurized), while solenoid S2 is de-energized (i.e., depressurized). In that mode, solenoid S1 connects the leftmost pilot cylinder of the spool valve directly to the pilot pressure source. Solenoid S2 connects the rightmost pilot cylinder of the spool valve to exhaust. And solenoid S3 connects a spring-return pilot-operated 2-way valve to the pressure source, which causes the control spool of the spring-return pilot-operated 2-way valve to move downward against the biasing of its bias spring. When the control spool of the spring-return pilot-operated 2-way valve is down, auxiliary flow channel 2̂ is unblocked. In view of the foregoing, in the S1 energized configuration, the pressure differential between the two pilot cylinders causes the spool to move to the right, which connects output port 2 to pressure port 1 and output port 4 to exhaust 5 (i.e., configures the valve in the first standard port connectivity configuration). The S2 energized configuration (i.e., PLC1=0, PLC2=1) merely reverses which of solenoids S1 and S2 is energized (solenoid S3 remains energized). As such, the rightmost pilot cylinder of the spool valve is connected directly to the pressure source by solenoid S2, while the leftmost pilot cylinder is connected to exhaust by solenoid S1. The pressure differential between the two pilot cylinders thereby causes the spool to move to the left when the valve is in the S2 energized configuration, which connects output port 4 to pressure port 1 and output port 2 to exhaust port 3 (i.e., the second standard port connectivity configuration). In dwell mode, solenoids S1 and S2 are de-energized while solenoid S3 remains energized. This connects both pilot cylinders of the spool valve to exhaust, thereby causing the spool of the spool valve to move to its equilibrium position. Because the pressurization of the 2-way valve by solenoid S3 keeps auxiliary flow channel 2̂ is unblocked and because auxiliary flow channels 2̂ and 4̂ are in communication with each other when the spool is in equilibrium, output port 2 is operatively connected to output port 4 in dwell mode. In S1 manual override (MO) mode, solenoid S1 manually activated (i.e., pressurized) while the others are depressurized (although S3 can be in either state). As such, in S1 manual mode the spool valve makes the same port-to-port connections it makes as when the valve is in the S1 energized mode. Likewise, in S2 manual mode, solenoid S2 is manually activated (pressurized) while the others are depressurized and the spool valve therefore makes the same port-to-port connections it makes as when the valve is in the S2 energized mode. In the de-energized mode, all solenoids are de-energized (i.e., depressurized), which connects both pilot cylinders to exhaust and moves the spool of the spool valve to its equilibrium position. This is similar to the dwell mode, except that solenoid S3 is also depressurized, such that the control spool of 2-way valve will move up as a result of its biasing spring, where it will then block auxiliary flow channel 2̂, and therefore will isolate auxiliary flow channel 2̂ (and thus output port 2) from communicating with output port 4 and auxiliary flow channel 4̂. Thus output ports 2 and 4 are blocked and cannot communicate with each other. As such, all ports are blocked, and the energy-saving 3P-APB valve will provide the same de-energized port connectivity as a standard 3P-APB valve.

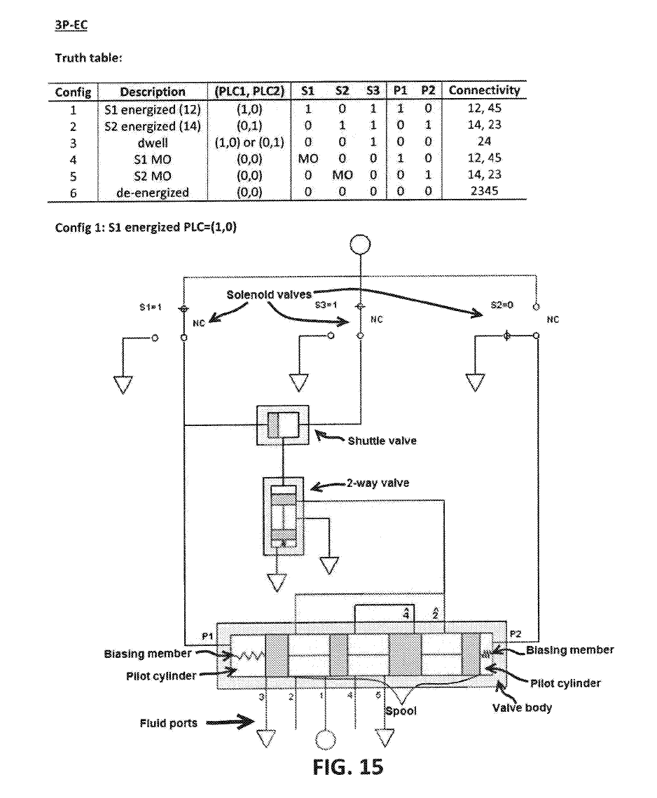

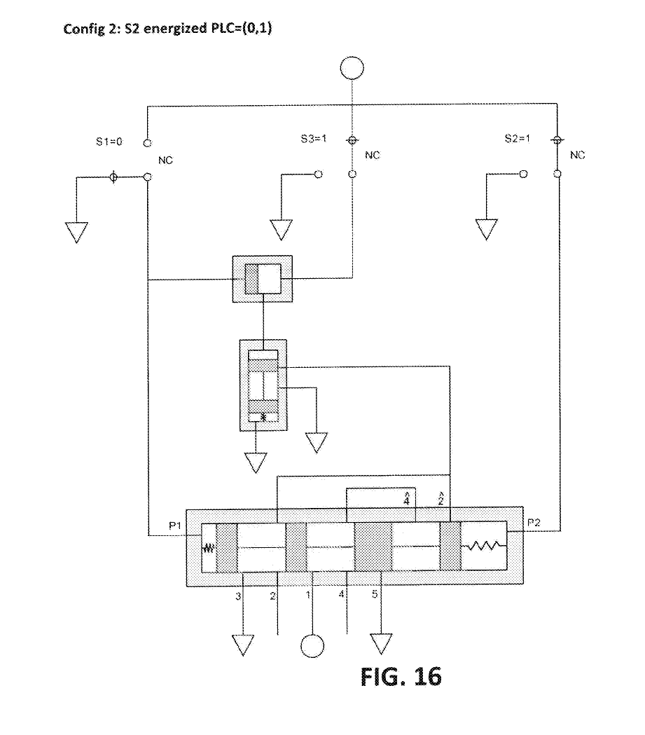

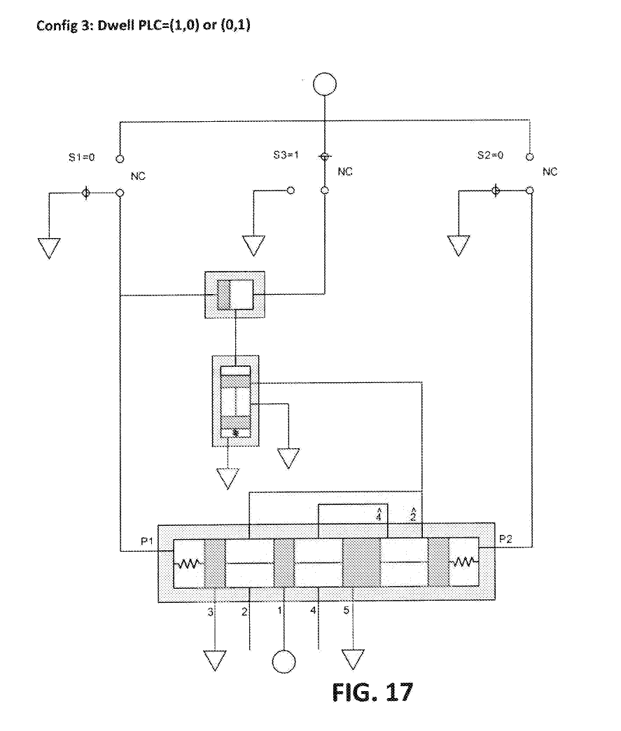

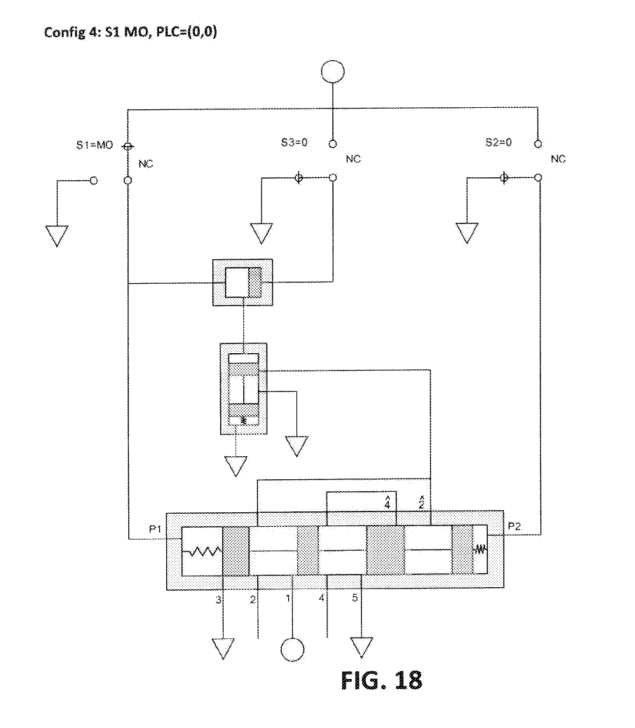

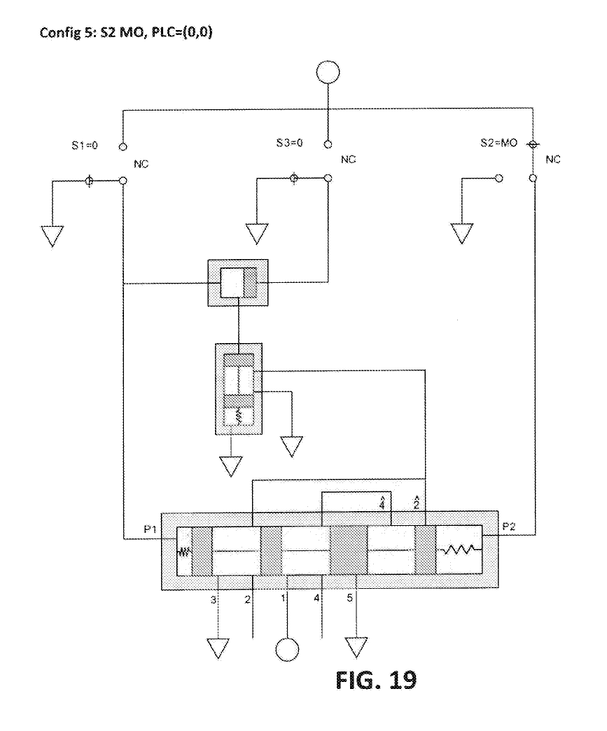

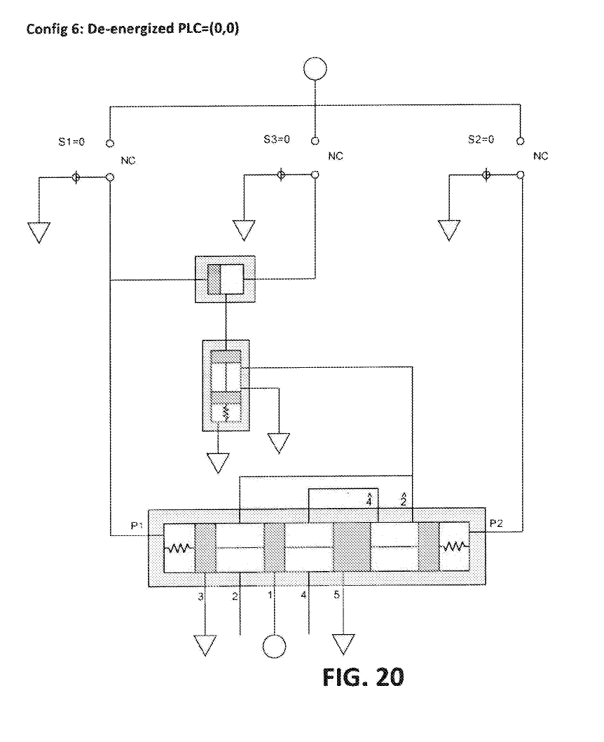

A 3P-EC configured valve is shown in FIGS. 15-20. This valve embodiment comprises three solenoids (S1, S2, S3), a shuttle valve, and a spring-return pilot-operated 2-way valve. All of the solenoids are normally closed (depressurized) when de-energized. The three solenoids are operated by two PLC commands (PLC1 and PLC2), and require override compatibility with two MO inputs (S1 MO and S2 MO). In the S1 energized mode (PLC1=1, PLC2=0), shown in FIG. 15, solenoid S1 and solenoid S3 are activated (pressurized), while solenoid S2 is de-energized (depressurized). Solenoid S1 and solenoid S3 connect to opposite sides of the shuttle valve, and when either or both solenoid S1 and solenoid S3 are activated, the shuttle valve connects the 2-way valve to a pressure source, which moves the spool of the two-way valve down, countering the biasing spring of the two-way valve and blocking a fluid connection to chambers of the spool valve. Energizing solenoid S1 also directly connects the leftmost pilot cylinder of the spool valve to the pressure source. With solenoid S2 de-energized, the rightmost pilot cylinder is connected to exhaust. As such, the spool of the spool valve moves to the right as shown. This connects output port 2 to the pressure supply port 1 and connects output port 4 to exhaust port 5. In the S2 energized mode (PLC1=0, PLC2=1), shown in FIG. 16, solenoids S2 and S3 are energized, while solenoid S1 is de-energized. Thus, the two-way valve still blocks the fluid connection to chambers of the spool valve. Energizing solenoid S2 directly connects the rightmost pilot cylinder to a supply pressure. Conversely, de-energizing solenoid S1 connects the leftmost pilot cylinder to exhaust. As a result, the spool of the spool valve moves to the left as shown in FIG. 16. In that position, output port 2 is connected to exhaust port 3 and output port 4 is connected to pressure supply port 1. In the dwell mode, shown in FIG. 17, the only solenoid energized is solenoid S3. Thus, each of the pilot cylinders of the spool valve are connected to exhaust, and the spool valve moves to its spring biased equilibrium position. Like the other valve configurations, in the equilibrium position in dwell mode, auxiliary flow channels 2̂ and 4̂ are in communication with each other and therefore output port 2 is operatively connected to output port 4 while the exhaust ports are blocked. In the S1 manual override mode, shown in FIG. 18, solenoid S1 is manually activated while solenoids S2 and S3 are de-energized. This provides the same effect and port connectivity as the S1 energized mode since the shuttle valve can pressurize the two-way valve provided if either or both of solenoids S1 and S3 are energized. It should be noted that, if not for the shuttle valve connection to solenoid S1, the S1 MO would not function correctly, since supply (input port 1) would be connected to exhaust via the 2-way valve connection between port 2̂ and exhaust, and thus the valve would create a short-circuit connecting supply directly to exhaust. In the S2 manual override mode, shown in FIG. 19, solenoid S2 is manually activated while solenoids S1 and S3 are de-energized. This moves the spool of the spool valve to the left in the same manner that the S2 energized mode does and the port-to-port connectivity is identical, with one exception. Since both solenoid S1 and solenoid S3 are de-energized, the pressure actuation of the two-way valve is lost and the spool of the two-way valve therefore moves upward via the spring biasing force. That results in the two-way valve connecting the fluid connection between the chambers of the primary spool valve to exhaust. However, that has no impact since output port 4 remains connected only to pressure input port 1 and output port 2 is already connected to exhaust port 3 (nonetheless, unlike S2 energized mode, output port 2 is also connected to exhaust through the two-way valve in S2 manual override mode). In the de-energized mode, shown in FIG. 20, solenoids S1, S2, and S3 of this valve are all de-energized and therefore de-pressurized. As a result, the configuration is similar to the dwell mode, except that the two-way valve now connects the fluid connection between the chambers of the primary spool valve to exhaust. As can be appreciated from FIG. 20, output port 2 and output port 4 are therefore connected to exhaust (in addition to each other) through auxiliary flow channels 2̂ and 4̂. Additionally, the spool blocks the pressure input port 1 from communicating with either outlet port.

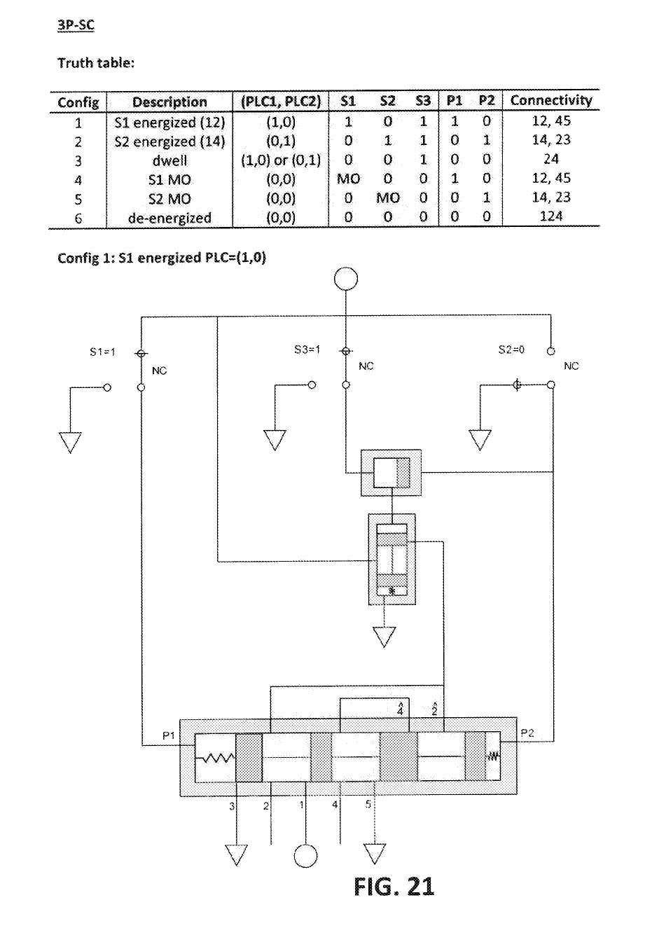

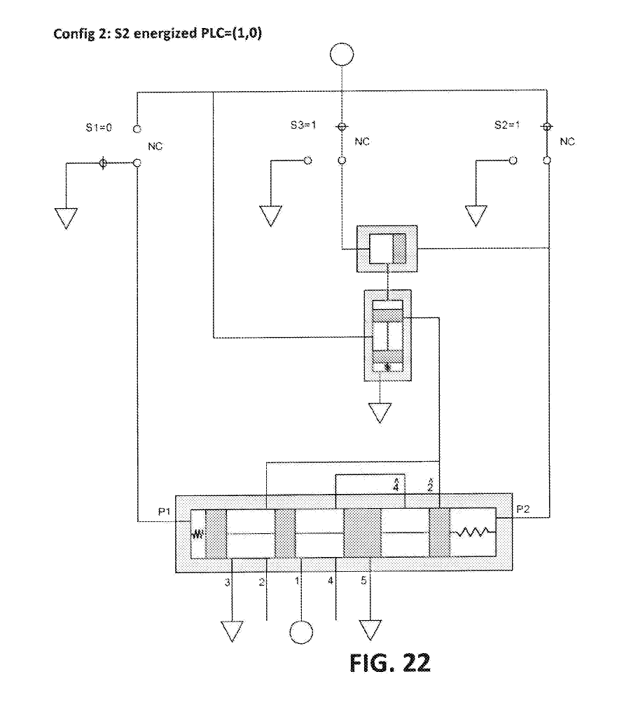

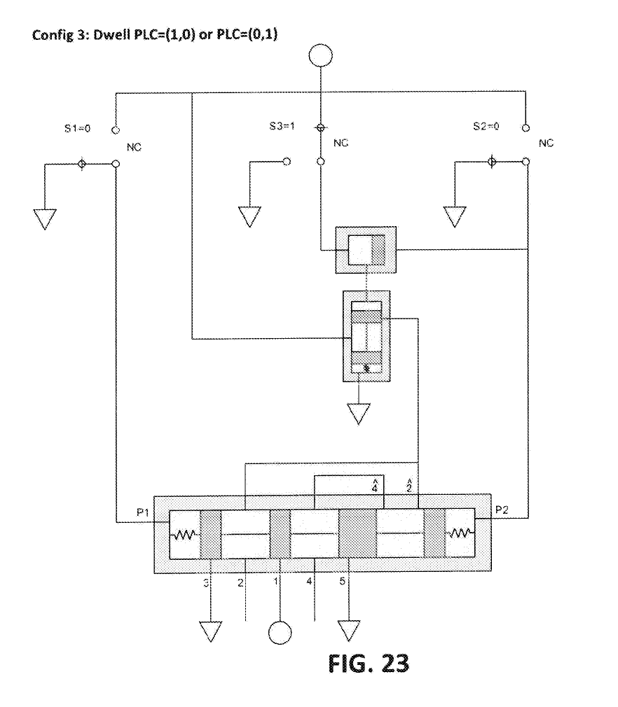

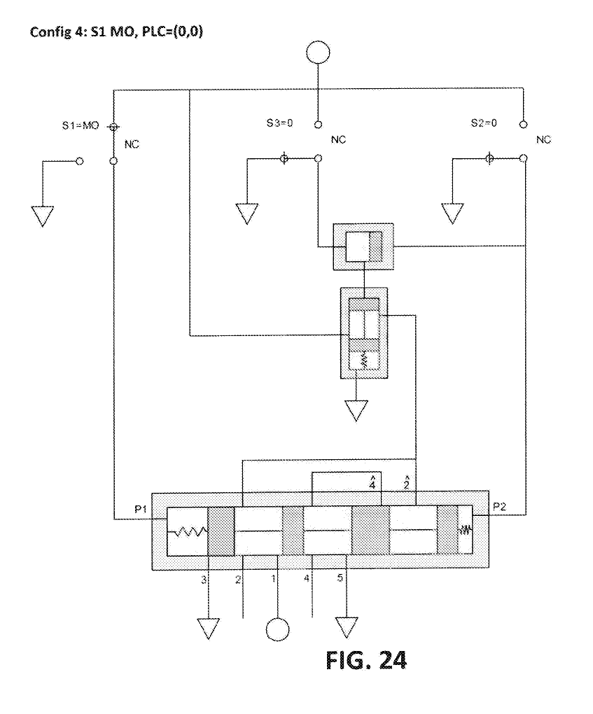

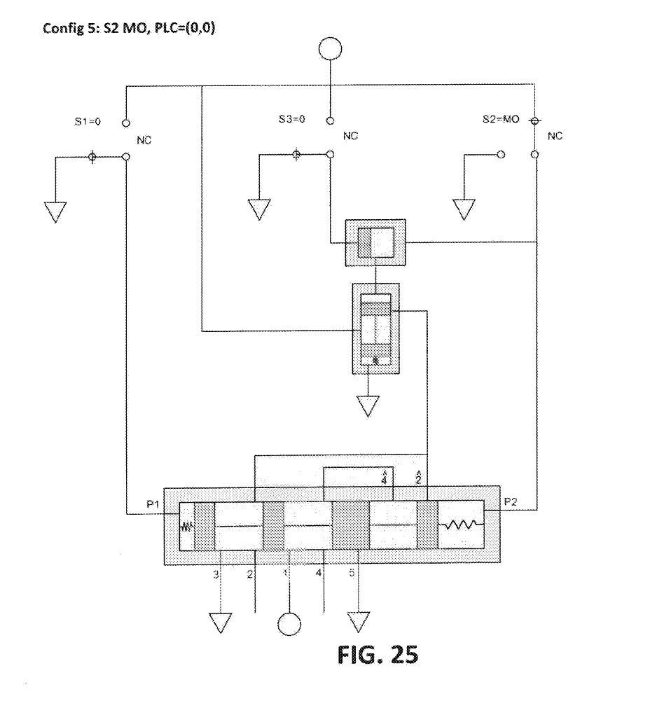

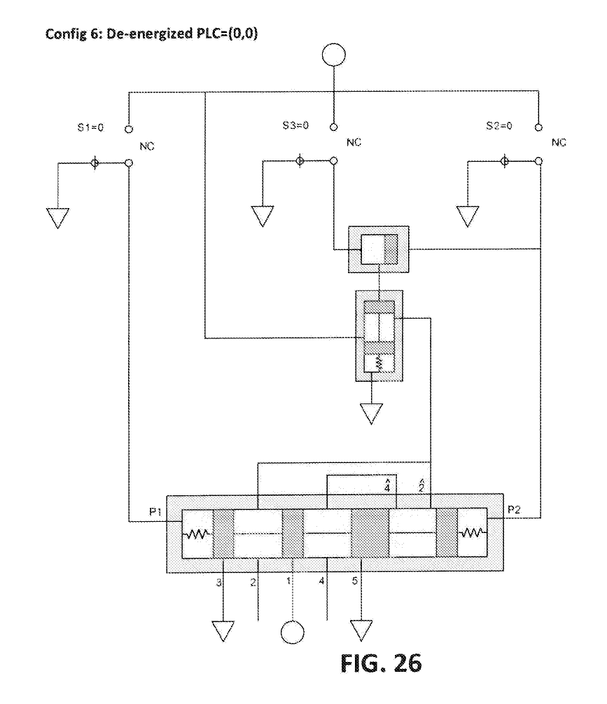

A 3P-SC configured valve is shown in FIGS. 21-26. This valve configuration is somewhat similar to the 3P-EC configured valve described immediately above in that it comprises three solenoids (S1, S2, and S3) which are all closed when de-energized, a shuttle valve, and a spring-return pilot-operated 2-way valve. The three solenoids are operated by two PLC commands (PLC1 and PLC2), and require override compatibility with two MO inputs (S1 MO and S2 MO).The differences between the EC and SC configurations are that the shuttle valve is connected to solenoid S2 and solenoid S3 rather than solenoid S1 and solenoid S3, and that the two-way valve is configured to selectively connect the same fluid connection between the chambers of the primary spool valve to a pressure source rather than exhaust. Hence, as is evident to one of ordinary skill in the art from FIGS. 21-23 and 25, this valve embodiment operates similarly to the 3P-EC configured valve described immediately above in the S1 energized, S2 energized, dwell, and S1 manual override modes. However, in the S2 manual override mode, shown in FIG. 25, activation of solenoid S2 also pressurizes the 2-way valve, thus isolating port 2̂ from supply, which enables the standard port connectivity between port 2 and exhaust, and between port 4 and supply. If the shuttle valve were not connected to S2, the S2 MO would not function correctly, since supply would be connected directly to exhaust via the 2-way valve connection. In the fully de-energized state (i.e., PLC1=PLC2=0), as shown in FIG. 26, the main-spool biasing springs center the main spool, while the 2-way biasing spring moves the 2-way spool upward, resulting in a standard SC port connectivity of output port 2 and output port 4 connected to supply, while the exhaust ports are isolated.

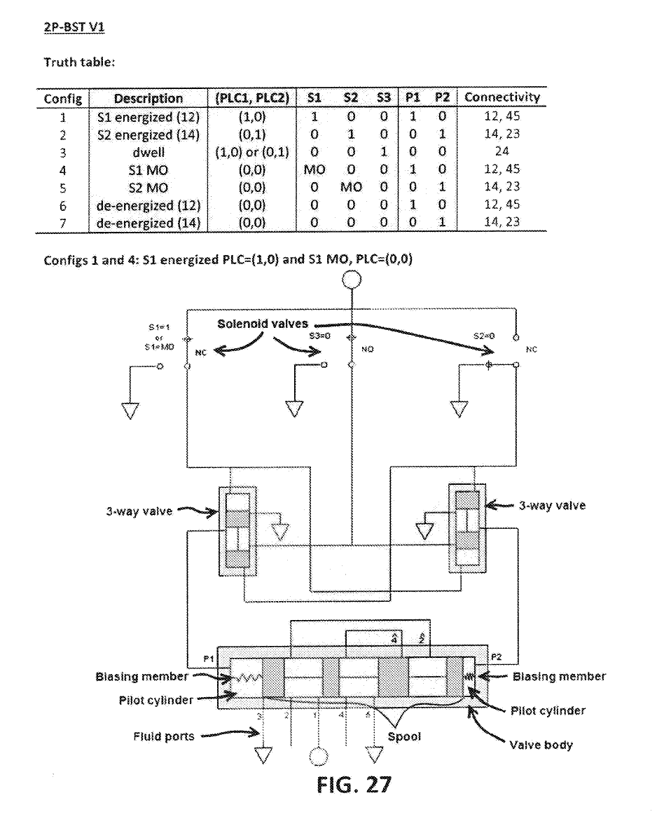

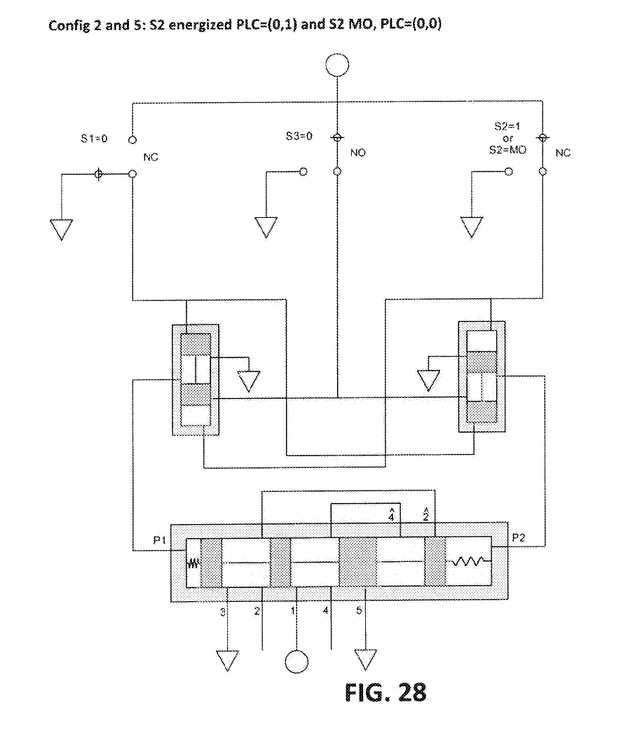

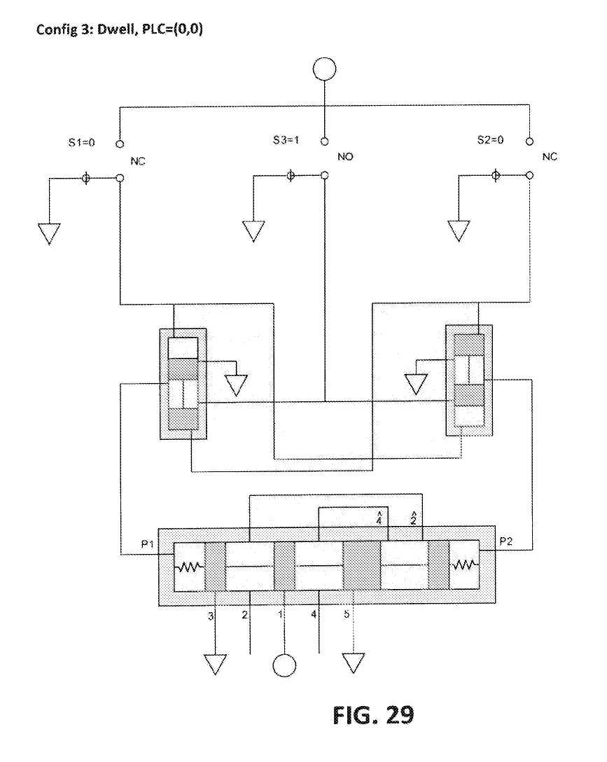

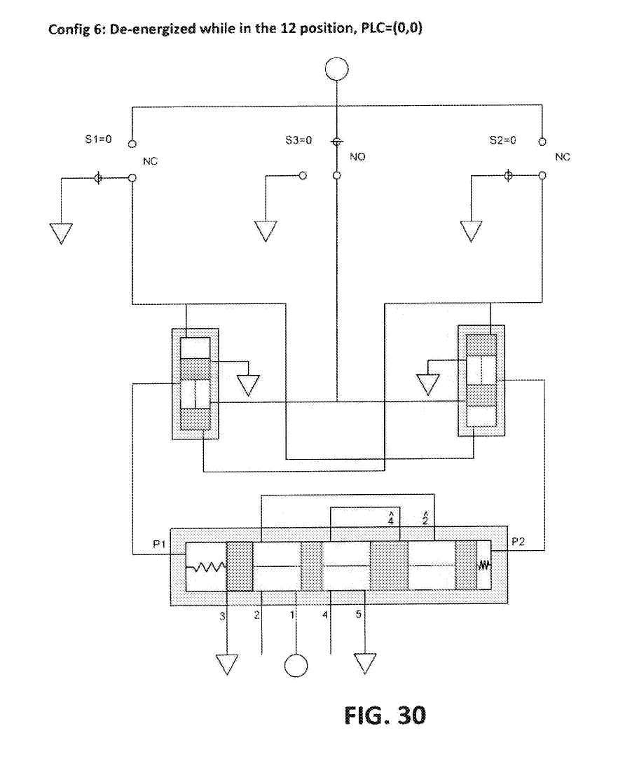

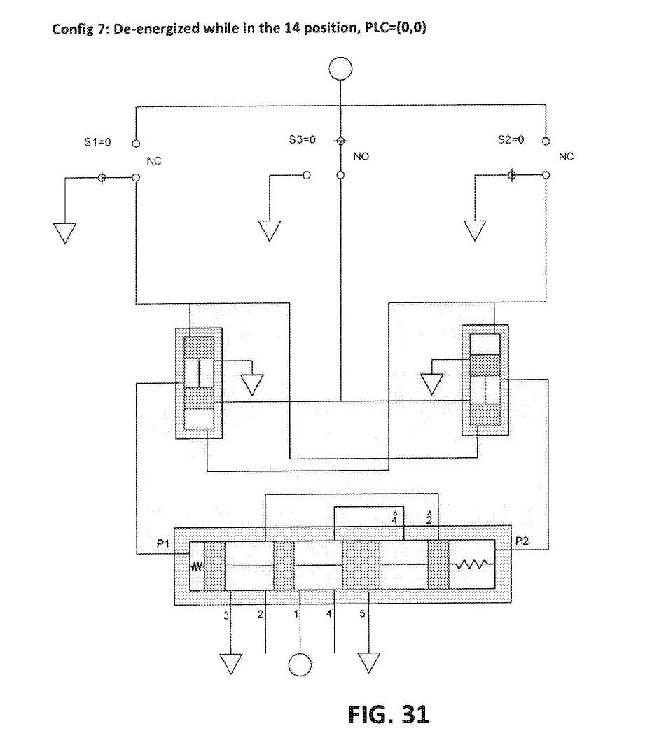

A first 2P-BST configured valve (2P-BST V1) is shown in FIGS. 27-31. In addition to the spool valve, this valve embodiment comprises two unspring-biased pressure-actuated three-way valves and three solenoids (S1, S2, and S3). The three solenoids are operated by two PLC commands (PLC1 and PLC2), and require override compatibility with two MO inputs (S1 MO and S2 MO). Solenoid S3 is normally open (i.e., pressurized when de-energized), whereas solenoid S1 and solenoid S2 are normally closed types (i.e., depressurized when de-energized). As is evident from FIG. 27, in the S1 energized mode (i.e., PLC1=1, PLC2=0) solenoid S1 is energized (pressurized), solenoid S2 is not (remains depressurized), and solenoid S3 is de-energized and thus depressurized. By opening solenoid S1 but not solenoid S2, the leftmost three-way valve connects the line feeding the leftmost pilot cylinder of the spool valve to a pressure source through solenoid S3. Conversely, this also causes the rightmost three-way valve to connect the rightmost pilot cylinder of the spool valve to exhaust. As such, like with the other valve embodiments, the spool of the spool valve moves to the right, thereby connecting output port 2 to pressure port 1 and output port 4 to exhaust port 5. In the S2 energized mode (PLC1=0, PLC2=1), shown in FIG. 28, solenoid S2 is energized (i.e., pressurized), solenoid S1 and S3 are de-energized, such that S1 is depressurized and S3 pressurized. As such, the leftmost three-way valve connects the line feeding the leftmost pilot cylinder of the spool valve to exhaust. Conversely, this also causes the rightmost three-way valve to connect the rightmost pilot cylinder of the spool valve to the pressure source through solenoid S3. Thus, like the other valve embodiments, the spool of the spool valve moves to the left, thereby connecting output port 4 to pressure port 1 and output port 2 to exhaust port 3. In the dwell mode, shown in FIG. 29, only solenoid S3 is energized and therefore all the solenoids are de-pressurized. Thus, regardless of which way the three-way valves are configured, both pilot cylinders of the spool valve are connected to exhaust and therefore the spool of the spool valve moves to its equilibrium position via the biasing springs of the spool valve. As such, like with the other valve embodiments, auxiliary flow channels 2̂ and 4̂ are in communication with each other and therefore output port 2 is operatively connected to output port 4 while the exhaust ports of the spool are blocked. As is evident from FIGS. 30 and 31, in the de-energized modes, with both solenoid S1 and solenoid S2 closed, the three-way valves remain in their current configurations since no differential pressures act upon them (it is assumed that gravitational forces are insignificant relative to frictional forces on the respective spools). Thus, de-energization doesn't change the port connections of the spool valve when the spool valve was previously in either the S1 energized mode or the S2 energized mode. The S1 manual override and S2 manual override modes are not shown, but simple activation of solenoid S1 or solenoid S, respectively, will duplicate the configurations of the S1 energized mode or the S2 energized mode, respectively.

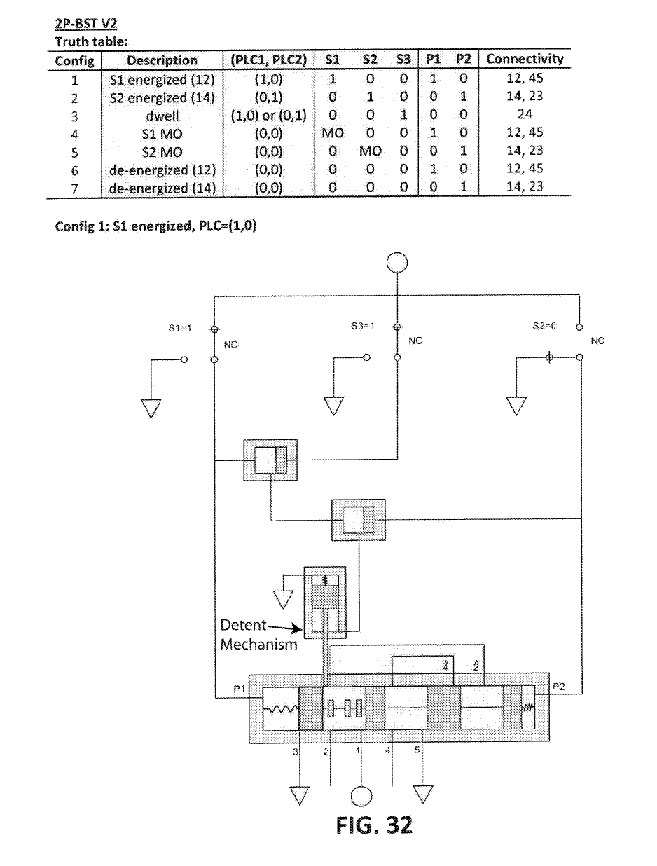

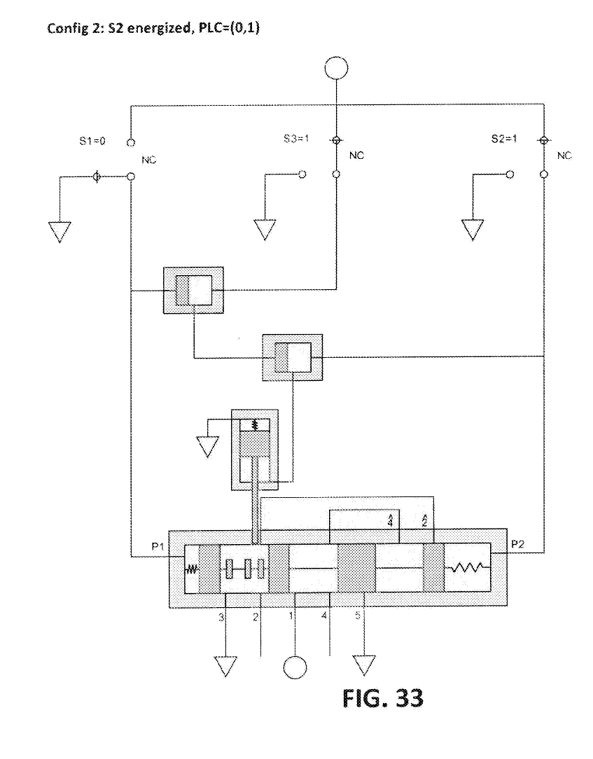

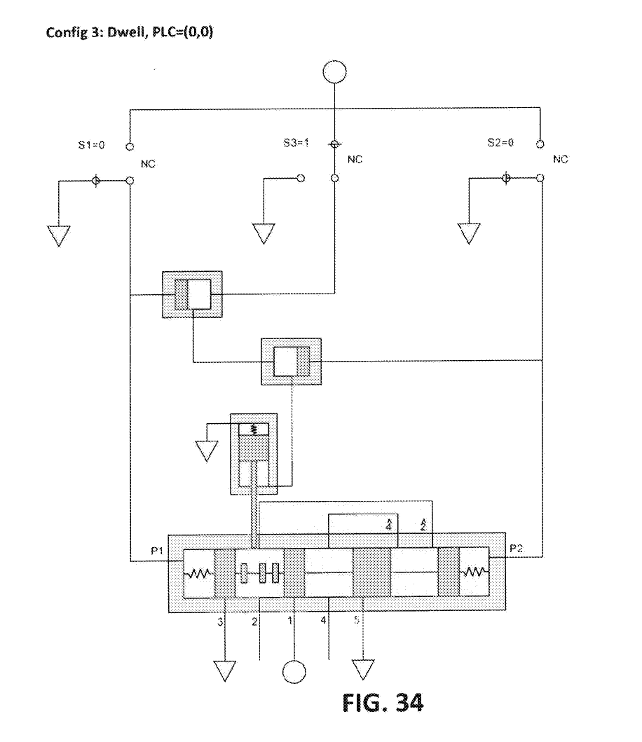

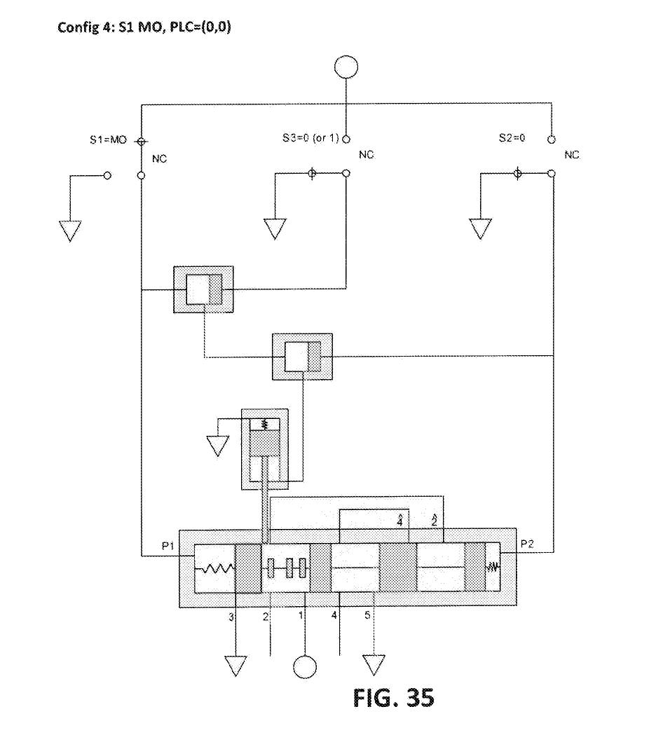

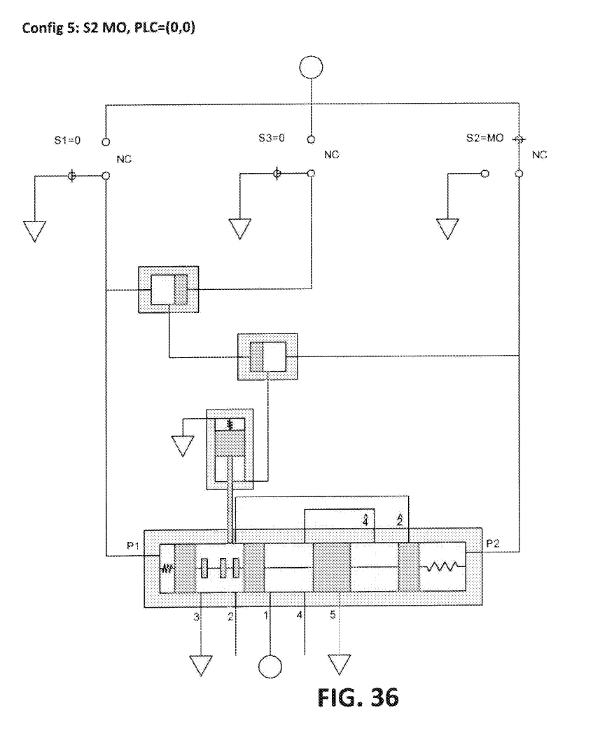

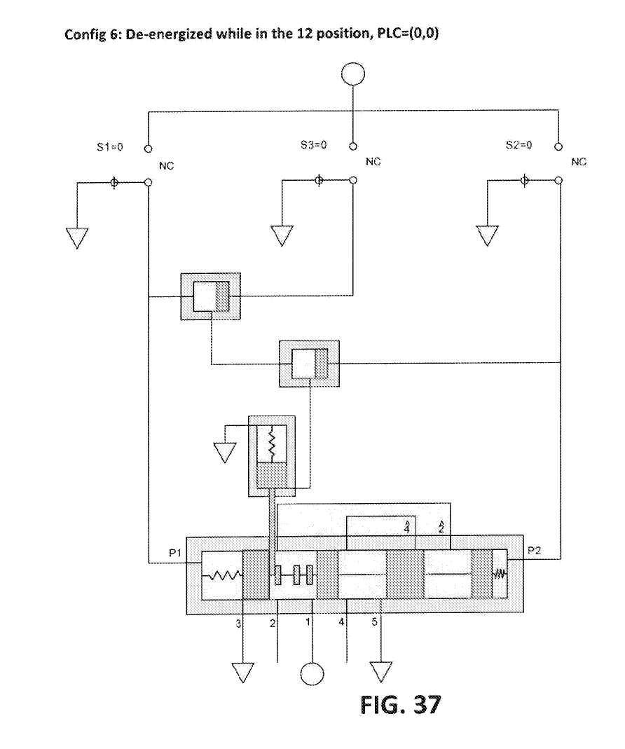

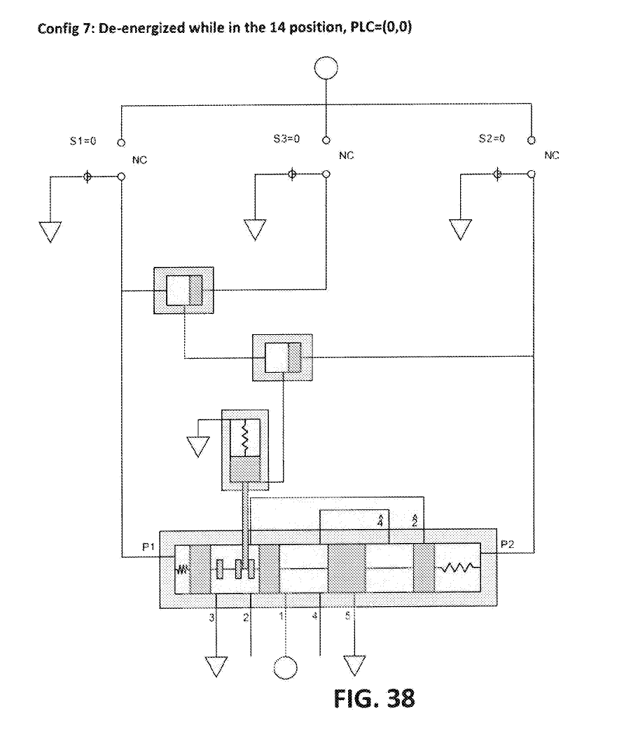

A second 2P-BST (2P-BST V2) configured valve is shown in FIGS. 32-38. In addition to a spool valve, this valve embodiment comprises three solenoids (S1, S2, S3), two shuttle valves, and a spring-biased pressure actuated detent mechanism. All of the solenoids are normally closed when de-energized. The three solenoids are operated by two PLC commands (PLC1 and PLC2), and require override compatibility with two MO inputs (51 MO and S2 MO). In the S1 energized mode, shown in FIG. 32, solenoid S1 and solenoid S3 are energized while solenoid S2 remains de-energized. This causes the shuttle of the lowermost shuttle valve to move to the right since that side of the shuttle valve is connected to exhaust via solenoid S2 and since the opposite side of that shuttle valve is connected to a pressure source through the upper shuttle valve and either solenoid S1 or solenoid S3. The lower shuttle valve delivers pressure to the detent mechanism, which retracts a detent pin from the spool valve. In this mode, solenoid S1 also connects the leftmost pilot cylinder of the spool valve to pressure while solenoid S2 connects the rightmost pilot cylinder of the spool valve to exhaust. Thus, the spool of the spool valve moves to the right as shown, thereby connecting outlet port 2 to pressure port 1 and outlet port 4 to exhaust port 5. In the S2 energized mode, shown in FIG. 33, solenoid S2 and solenoid S3 are energized while solenoid S1 is de-energized. In that case, the detent mechanism receives pressure through the lower shuttle valve and solenoid S2 and therefore the detent pin is retracted from the spool valve. In this mode, solenoid S1 also connects the leftmost pilot cylinder of the spool valve to exhaust while solenoid S2 connects the rightmost pilot cylinder of the spool valve to pressure. Thus, the spool of the spool valve moves to the left as shown, thereby connecting outlet port 2 to exhaust port 3 and outlet port 4 to pressure port 1. In the dwell mode, shown in FIG. 34, only solenoid S3 is energized, which connects the detent mechanism to pressure via the two shuttle valves. As such, the detent pin is retracted from the spool valve. With solenoid S1 and solenoid S2 closed, the pilot cylinders of the spool valve are connected to exhaust and the spool of the spool valve therefore moves to its spring biased equilibrium position as shown. As such, like with the other valve embodiments, auxiliary flow channels 2̂ and 4̂ are in communication with each other and therefore output port 2 is operatively connected to output port 4 while the exhaust ports of the spool are blocked. In the S1 manual override mode, shown in FIG. 35, solenoid S1 is manually opened while the other solenoids are de-energized and therefore closed. In this situation, the detent mechanism still receives pressure via the two shuttle valves and solenoid S1. As such, the detent pin is retracted from the spool valve. With solenoid S1 energized, the leftmost pilot cylinder of the spool valve is connected to pressure while solenoid S2 connects the rightmost pilot cylinder of the spool valve to exhaust. Thus, the spool of the spool valve moves to the right as shown and thereby connects outlet port 2 to pressure port 1 and outlet port 4 to exhaust port 5. In the S2 manual override mode, shown in FIG. 36, solenoid S2 is manually opened while the other solenoids are de-energized and therefore closed. In this situation, the detent mechanism still receives pressure via the lower of the two shuttles valves and solenoid S2. As such, the detent pin is retracted from the spool valve. With solenoid S2 energized, the rightmost pilot cylinder of the spool valve is connected to pressure while solenoid S1 connects the leftmost pilot cylinder of the spool valve to exhaust. Thus, the spool of the spool valve moves to the left as shown and thereby connects outlet port 2 to exhaust port 3 and outlet port 4 to pressure port 1. When de-energized with the spool moved to the right as shown in FIG. 37, the detent mechanism is no longer supplied pressure and the spring biased detent pin therefore moves down in the spool valve and into a detent of the spool. That prevents the spool from moving to its equilibrium position even though both pilot cylinders of the spool valve are connected to exhaust. Thus, outlet port 2 remains connected to pressure port 1 and outlet port 4 remains connected to exhaust port 5. In a similar manner, when de-energized with the spool moved to the left as shown in FIG. 38, the detent mechanism is no longer supplied pressure and the spring biased detent pin therefore moves down in the spool valve and into another detent of the spool. That also prevents the spool from moving to its equilibrium position even though both pilot cylinders of the spool valve are connected to exhaust. Thus, outlet port 2 remains connected to exhaust port 3 and outlet port 4 remains connected to input port 1.

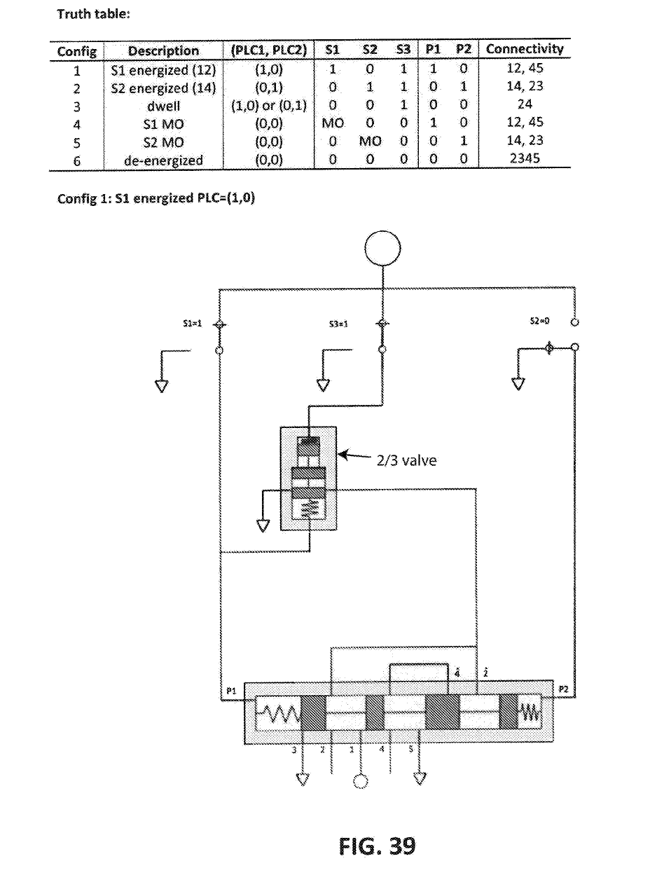

Another embodiment of a 3P-EC (3P-EC V2) configured valve is shown in FIGS. 39-44. This valve embodiment has three normally closed solenoids (S1, S2, S3) and achieves the desired input/output characteristics of 3P-EC using a pilot-actuation 2-port, 3-position (2/3) normally open (NO) valve as a pneumatic logic element in place of the combination shuttle/two-position valve used in the 3P-EC V1 valve embodiment. The 2/3 valve has asymmetric piston bores with the output of solenoid S3 connected as the pilot to the small bore and the output of solenoid S1 connected as the pilot to the large bore. The two ports are connected to exhaust and the auxiliary flow channel 2̂ of the primary spool valve. The 2/3 valve performs a pneumatic logical OR function in that when either solenoid S1 or solenoid S3 are open then the auxiliary flow channel 2̂ is not connected to exhaust, i.e. the valve is closed. However, if solenoid S1 and solenoid S3 are both closed then the valve is spring-centered such that the auxiliary flow channel 2̂ becomes connected to exhaust, i.e. the valve is open. Valve embodiments for the 3P-SC V2 and 3P-APB V2 configurations can also be achieved in a similar fashion. The 3P-SC V2 embodiment would be almost identical to the 3P-EC V2 embodiment with an exception that the 2/3 NO valve would be connected to supply pressure rather than exhaust. The 3P-APB V2 valve embodiment would incorporate the 2/3 valve as a normally closed (NC) valve and connect the ports to either side of the equalization channel.

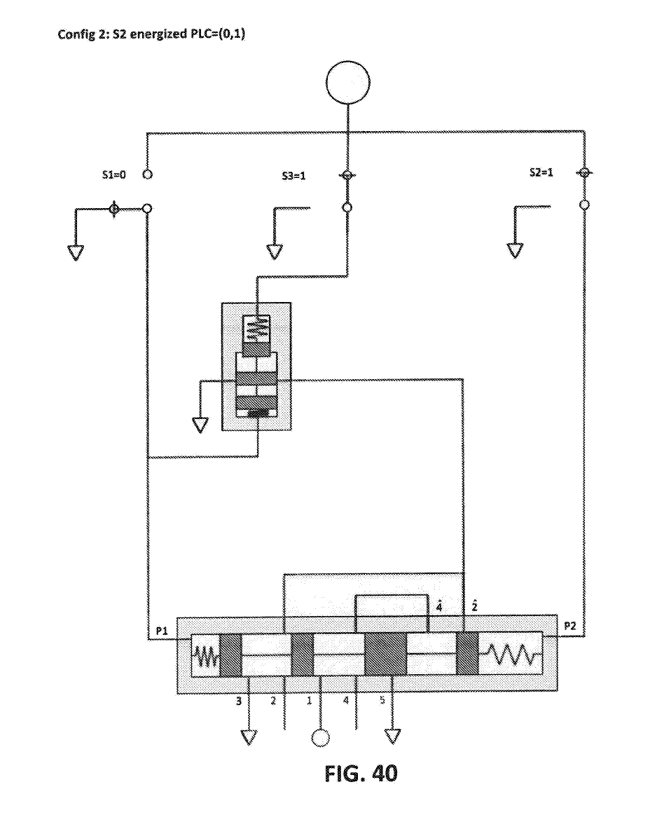

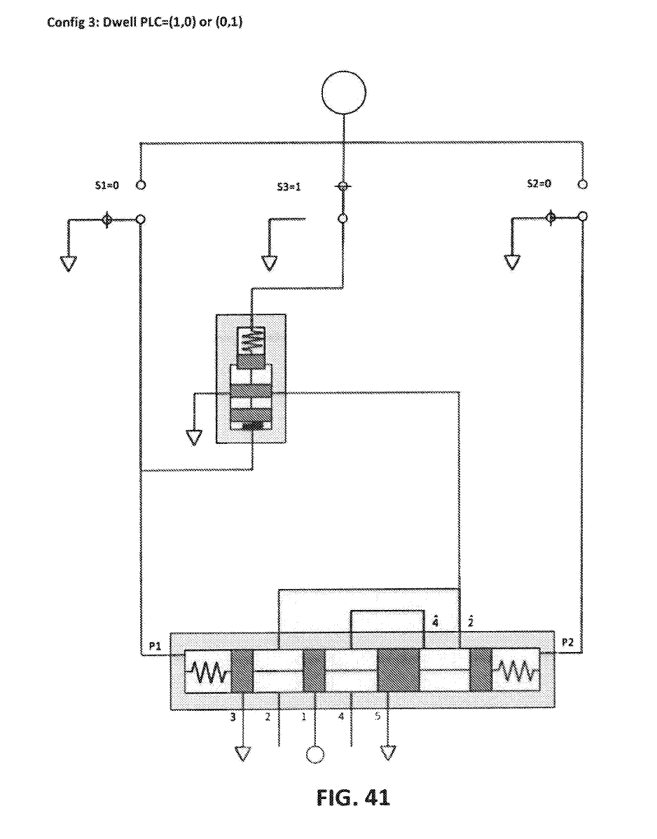

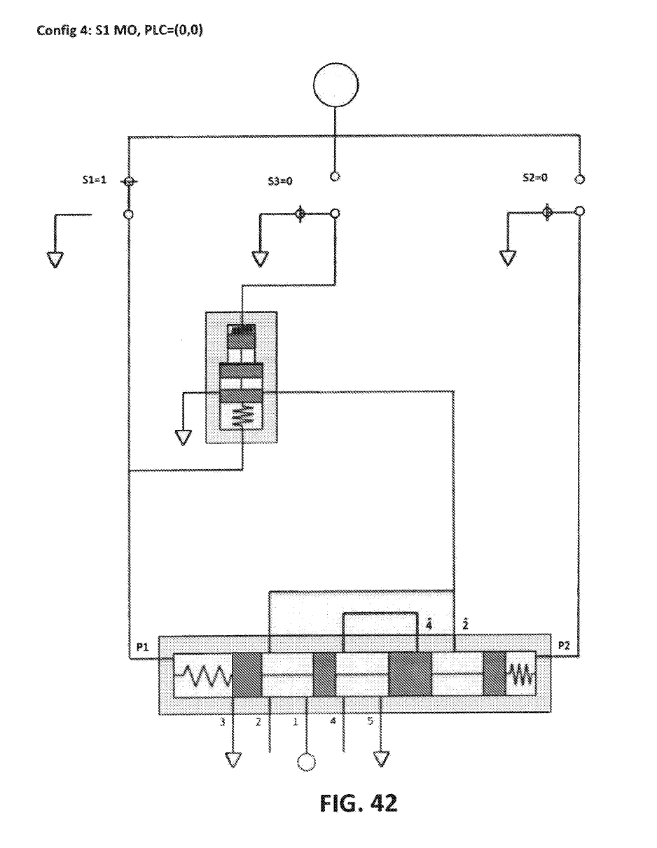

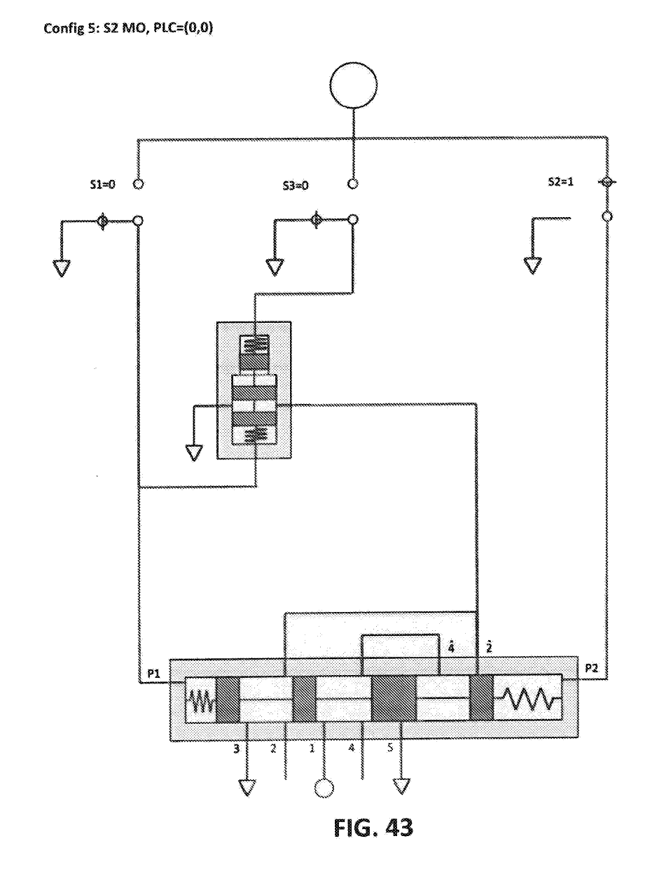

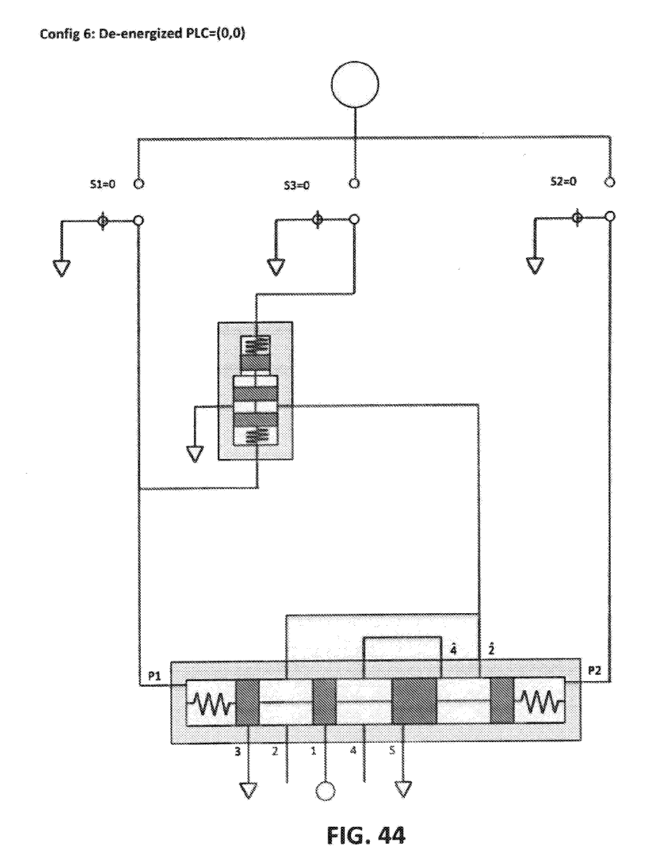

In operation and when set in the S1 energized mode, as shown in FIG. 39, solenoid S1 and solenoid S3 of the 3P-EC (3P-EC V2) valve embodiment are energized, while solenoid S2 is not. As such solenoid S1 connects the leftmost pilot cylinder of the spool valve to pressure while solenoid S2 connects the rightmost pilot cylinder of the spool valve to exhaust and the spool of the spool valve therefore moves to the right as shown, which connects outlet port 2 to pressure port 1 and outlet port 4 to exhaust port 5. In the S2 energized mode, shown in FIG. 40, solenoid S2 and solenoid S3 are opened while solenoid S1 is closed. Thus, solenoid S1 connects the leftmost pilot cylinder of the spool valve to exhaust while solenoid S2 connects the rightmost pilot cylinder of the spool valve to pressure. Thus, the spool of the spool valve moves to the left as shown and thereby connects outlet port 2 to exhaust port 3 and outlet port 4 to pressure port 1. In the dwell mode, shown in FIG. 41, only solenoid S3 is energized and therefore both pilot cylinders of the main spool valve are connected to exhaust. Thus, the spool valve moves to its spring biased equilibrium position and auxiliary flow channels 2̂ and 4̂ are in communication with each other and therefore output port 2 is operatively connected to output port 4 while the exhaust ports are blocked. In S1 manual mode, shown in FIG. 42, solenoid S1 is opened while solenoid S2 and solenoid S3 are not. Nonetheless, the 2/3 valve remains closed in view of the pressure received from solenoid S1. As such, then valve functions identically to the S1 energized mode. In the S2 manual override mode, as shown in FIG. 43, solenoid S2 is opened and solenoid S1 and solenoid S3 are closed. As such, the spool of the spool valve moves to the left, just as it does in the S2 energized state and therefore connects output port 2 to exhaust port 3 and output port 4 to supply port 1. Notably, in this mode the 2/3 valve opens. However the only impact that has is to connect output port 2 to a second exhaust route through auxiliary flow channels 2̂ and the 2/3 valve. In the de-energized mode, as shown in FIG. 44, all solenoid valves are closed and the 2/3 valve therefore is open. Thus the spool of the main spool valve moves to its equilibrium position, but instead of that merely connecting output port 2 to output port 4, it also connects said output ports to exhaust through auxiliary flow channel 2̂ and the 2/3 valve.

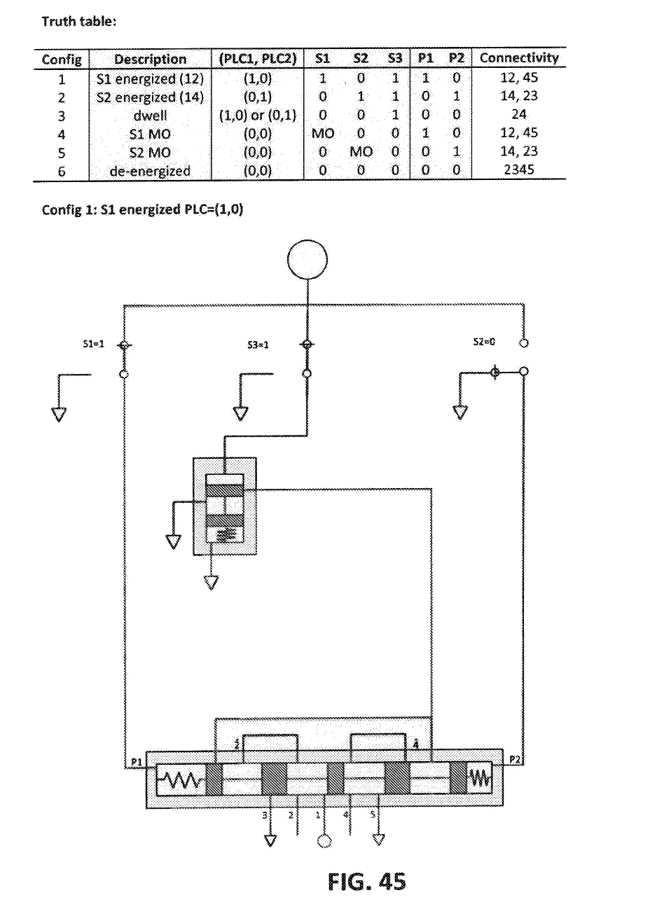

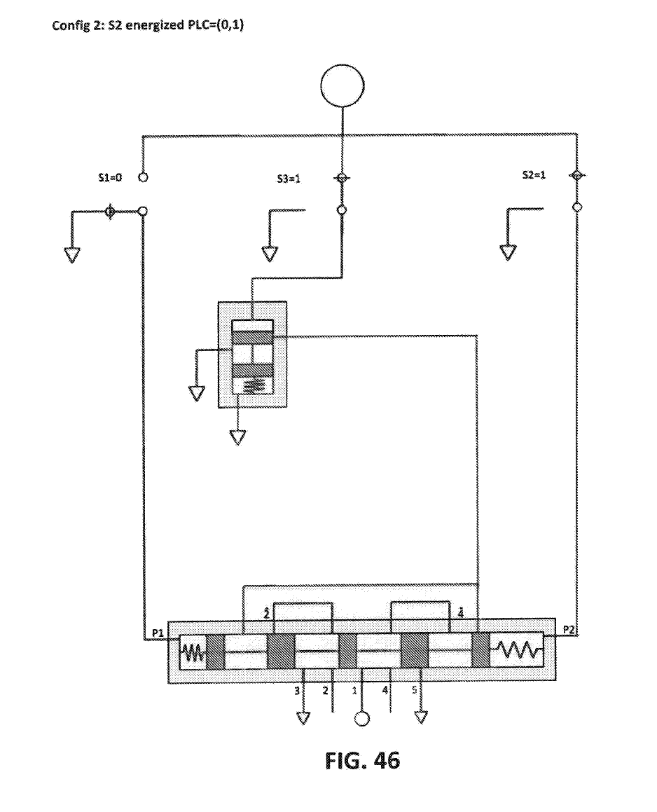

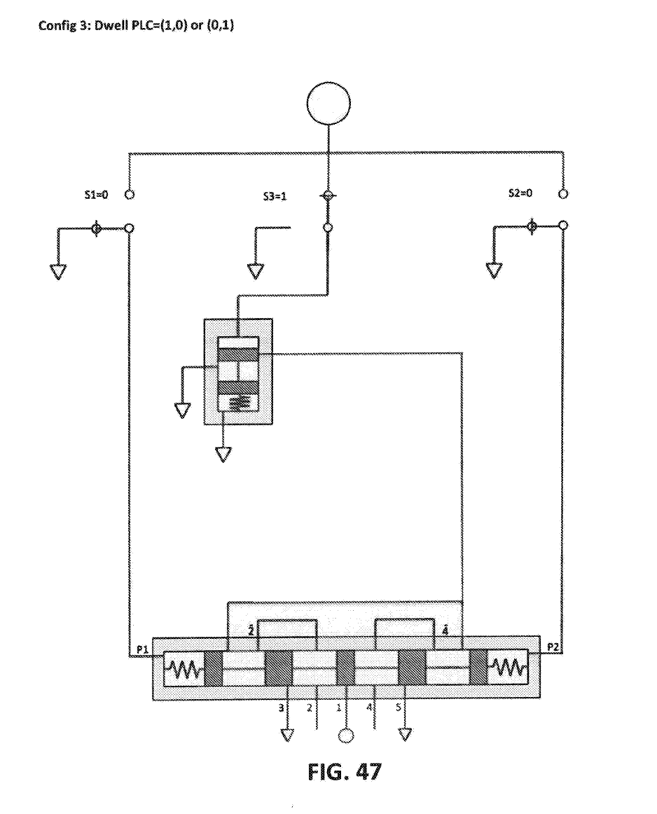

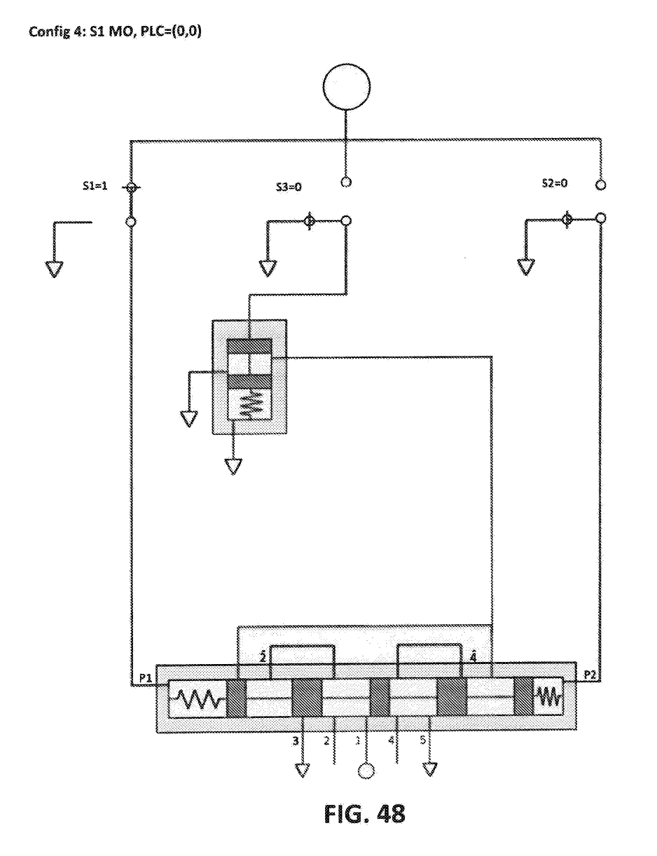

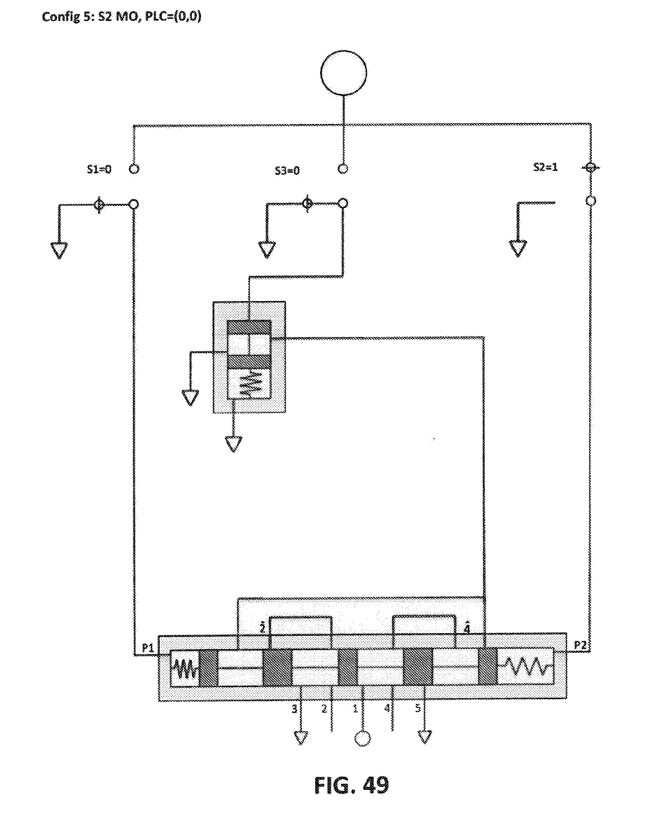

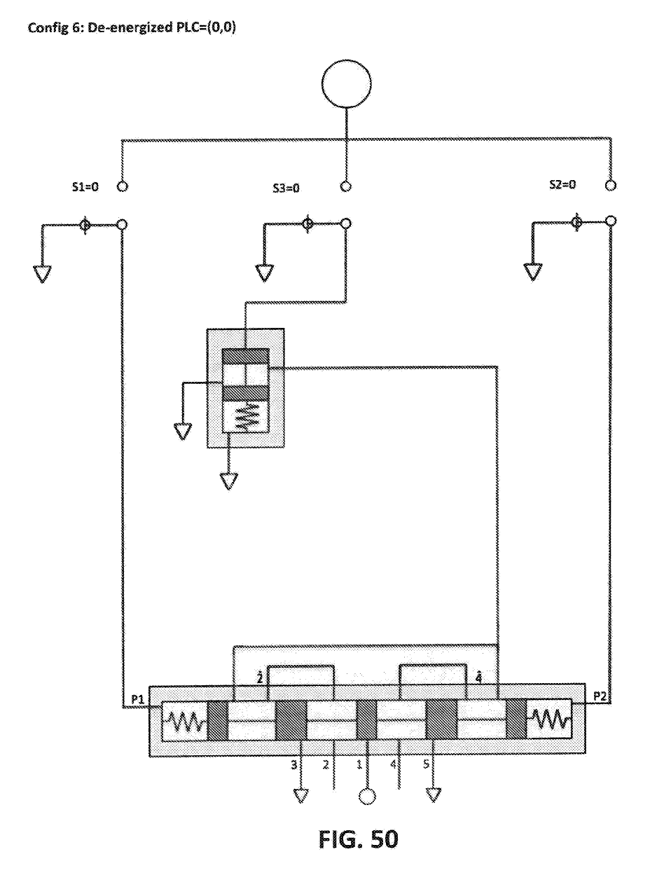

Another embodiment of a 3P-EC (3P-EC V3) configured valve is shown in FIGS. 45-50. In this valve embodiment, auxiliary flow channel 2̂ and auxiliary flow channel 4̂ are routed differently. This valve comprises three normally closed solenoids (S1, S2, S3) and a spring-biased pressure actuated two-way valve. The piston bore of the two-way valve is connected to solenoid S3. When solenoid S3 is open, the two-way valve is closed. When solenoid S3 is closed, the two-way valve opens and connects a flow channel that is connected to the main spool valve to exhaust. Solenoid S1 is connected only to the leftmost pilot cylinder of the spool valve and solenoid S2 is connected only to the rightmost pilot cylinder of the spool valve. In the S1 energized mode, as shown in FIG. 45, solenoid S1 and solenoid S3 are energized and opened, while solenoid S3 is not. Thus, the leftmost pilot cylinder of the spool valve is connected to supply pressure while the rightmost pilot cylinder of the spool valve is connected to supply, thereby moving the spool to the right as shown. In that position, outlet port 2 is connected to supply port 1 and outlet port 4 is connected to exhaust port 5. In the S2 energized mode, as shown in FIG. 46, solenoid S2 and solenoid S3 are energized and opened, while solenoid S1 is not. Thus, the leftmost pilot cylinder of the spool valve is connected to exhaust while the rightmost pilot cylinder of the spool valve is connected to supply pressure, thereby moving the spool to the left as shown. In that position, outlet port 2 is connected to exhaust port 3 and outlet port 4 is connected to supply port 1. In dwell mode, as shown in FIG. 47, only solenoid S3 is energized and therefore both pilot cylinders of the spool valve are connected to exhaust and the spool moves to its equilibrium position. In that position, auxiliary flow channel 2̂, auxiliary flow channel 4̂, and the fluid channel connecting the spool valve to the two-way valve collectively operatively connect output port 2 to output port 4. The spool closes all other ports. In the S1 manual override mode, as shown in FIG. 48, solenoid S1 is opened while solenoid S2 and solenoid S3 are closed. Thus, the leftmost pilot cylinder of the spool valve is connected to supply pressure while the rightmost pilot cylinder of the spool valve is connected to exhaust, thereby moving the spool to the right as shown. Additionally, the two-way valve opens. Nonetheless, the fluid channel connecting the spool valve to the two-way valve is not in communication with any of the ports of the spool valve. Thus, outlet port 2 is connected to supply port 1 and outlet port 4 is connected to exhaust port 5. In the S1 manual override mode, as shown in FIG. 49, solenoid S2 is opened while solenoid S1 and solenoid S3 are closed. Thus, the rightmost pilot cylinder of the spool valve is connected to supply pressure while the leftmost pilot cylinder of the spool valve is connected to exhaust, thereby moving the spool to the left as shown. Again, the two-way valve is open but the fluid channel connecting the spool valve to the two-way valve is not in communication with any of the ports of the spool valve. Thus, outlet port 2 is connected to exhaust port 3 and outlet port 4 is connected to supply port 1. In the de-energized mode, shown FIG. 50, all solenoids are closed and the two-way valve is open. As such, the spool of the spool valve moves to its equilibrium position. However, rather than merely connecting output port 2 to output port 4 in that position, both of said ports also operatively connect to the open two-way valve via the fluid conduit connecting the two-way valve to the spool valve. Thus, both output port 2 and output port 4 are also connected to exhaust.

In view of the foregoing, it should be appreciated that the invention has several advantages over the prior art.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

It should also be understood that when introducing elements of the present invention in the claims or in the above description of exemplary embodiments of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations. Still further, the order in which the steps of any method claim that follows are presented should not be construed in a manner limiting the order in which such steps must be performed, unless such an order is inherent.

What is claimed is:

1. A pilot-operated directional-control valve comprising:
a valve body;
at least four fluid ports;
a valve spool;
a first pilot cylinder;
a second pilot cylinder;
a first biasing member;
a second biasing member;
a normally-depressurized pilot solenoid valve;
a normally-pressurized pilot solenoid valve, wherein:
the at least four fluid ports, valve spool, the first pilot cylinder and the second pilot cylinder are disposed within the valve body;
the valve spool is moved to a first position when the first pilot cylinder is pressurized and the second pilot cylinder is de-pressurized;
the valve spool is moved to a second position when the second pilot cylinder is pressurized and the first pilot cylinder is de-pressurized;
the valve spool is moved to a third position by the first and second biasing members when the first and second pilot cylinders are de-pressurized;
the normally-depressurized pilot solenoid controls pressure to the first pilot cylinder;
the normally-pressurized pilot solenoid controls the pressure to the second pilot cylinder; and
the first pilot cylinder has a first diameter and the second pilot cylinder has a second diameter and second diameter is smaller than the first diameter.

2. The pilot-operated directional-control valve of claim 1 wherein the second diameter is at least 5 percent smaller than the first diameter.

3. The pilot-operated directional-control valve of claim 1 wherein the second diameter is at least 10 percent smaller than the first diameter.

4. The pilot-operated directional-control valve of claim 1 wherein the second diameter is at least 20 percent smaller than the first diameter.

5. The pilot-operated directional-control valve of claim 1 wherein the second diameter is at least 30 percent smaller than the first diameter.

6. The pilot-operated directional-control valve of claim 1, wherein:
the at least four fluid ports comprise a supply port, an exhaust port, a first outlet port, and a second outlet port;
when the valve spool is in the first position, the supply port and the first outlet port are in fluid communication and the exhaust port and the second outlet port are in fluid communication;
when the valve spool is in the second position, the supply port and the second outlet port are in fluid communication and the exhaust port and the first outlet port are in fluid communication; and
when the valve spool is the third position, the first outlet port and the second outlet port are in fluid communication and the supply port and the exhaust port are not in fluid communication.

7. A pilot-operated directional-control valve comprising:
a valve body;
at least four fluid ports;
a valve spool;
a first pilot cylinder;
a second pilot cylinder;
a first biasing member;
a second biasing member;
a normally-depressurized pilot solenoid valve;
a normally-pressurized pilot solenoid valve,
a shuttle valve comprising a first and second inlet port, and an outlet port; and
a spring-return pilot-operated 3-way valve, wherein:
the at least four fluid ports, the valve spool, the first pilot cylinder, the second pilot cylinder, the shuttle valve, and the spring-return pilot-operated 3-way valve are disposed within the valve body;
the valve spool is moved to a first position when the first pilot cylinder is pressurized and the second pilot cylinder is de-pressurized;
the valve spool is moved to a second position when the second pilot cylinder is pressurized and the first pilot cylinder is de-pressurized;
the valve spool is moved to a third position by the first and second biasing members when the first and second pilot cylinders are de-pressurized;
the outlet port of the shuttle valve supplies pilot pressure to the spring-return pilot-operated 3-way valve;
the spring-return pilot-operated 3-way valve pressurizes the second pilot cylinder when de-energized and de-pressurizes the second pilot cylinder when energized;
the normally-depressurized pilot solenoid controls the pressure to the first pilot cylinder and to the first inlet port of the shuttle valve; and
the normally-pressurized pilot solenoid controls the pressure to the second inlet port of the shuttle valve.

8. The pilot-operated directional-control valve of claim 7, wherein:
the at least four fluid ports comprise a supply port, an exhaust port, a first outlet port, and a second outlet port;
when the valve spool is in the first position, the supply port and the first outlet port are in fluid communication and the exhaust port and the second outlet port are in fluid communication;
when the valve spool is in the second position, the supply port and the second outlet port are in fluid communication and the exhaust port and the first outlet port are in fluid communication; and
when the valve spool is the third position, the first outlet port and the second outlet port are in fluid communication and the supply port and the exhaust port are not in fluid communication.

9. A pilot-operated directional-control valve comprising:
a valve body;
at least four fluid ports comprising a first outlet port and a second outlet port;
a valve spool;
a first pilot cylinder;
a second pilot cylinder;
a first biasing member;
a second biasing member;
a first normally-depressurized pilot solenoid valve;
a second normally-depressurized pilot solenoid valve;
a third normally-depressurized pilot solenoid valve; and
a spring-return pilot-operated 2-way valve comprising a pilot port, wherein:
the at least four fluid ports, the valve spool, the first pilot cylinder, the second pilot cylinder, the shuttle valve, and the spring-return pilot-operated 2-way valve are disposed within the valve body;
the valve spool is moved to a first position when the first pilot cylinder is pressurized and the second pilot cylinder is de-pressurized;
the valve spool is moved to a second position when the second pilot cylinder is pressurized and the first pilot cylinder is de-pressurized;
the valve spool is moved to a third position by the first and second biasing members when the first and second pilot cylinders are de-pressurized;
the spring-return pilot-operated 2-way valve controls fluid communication between the first outlet port and the second outlet port, such that the first outlet port and the second outlet port are in fluid communication when the spring-return pilot-operated 2-way valve is energized, and the first outlet port and the second outlet port are not in fluid communication when the spring-return pilot-operated 2-way valve is de-energized;
the first normally-depressurized pilot solenoid valve controls pressure to the first pilot cylinder;
the second normally-depressurized pilot solenoid valve controls pressure to the second pilot cylinder; and
the third normally-depressurized pilot solenoid valve controls pressure to the pilot port of the spring-return pilot-operated 2-way valve.

10. The pilot-operated directional-control valve of claim 9, wherein:
the at least four fluid ports also comprise a supply port and an exhaust port;
when the valve spool is in the first position, the supply port and the first outlet port are in fluid communication and the exhaust port and the second outlet port are in fluid communication;
when the valve spool is in the second position, the supply port and the second outlet port are in fluid communication and the exhaust port and the first outlet port are in fluid communication; and
when the valve spool is the third position, the first outlet port and the second outlet port are in fluid communication and the supply port and the exhaust port are not in fluid communication.

11. A pilot-operated directional-control valve comprising:
a valve body;
at least four fluid ports including a first outlet port and an exhaust port;
a valve spool;
a first pilot cylinder;
a second pilot cylinder;
a first biasing member;
a second biasing member;
a first normally-depressurized pilot solenoid valve;
a second normally-depressurized pilot solenoid valve;
a third normally-depressurized pilot solenoid valve;
a shuttle valve comprising a first inlet port, a second inlet port, and an outlet port; and
a spring-return pilot-operated 2-way valve, wherein:
the at least four fluid ports, the valve spool, the first pilot cylinder, the second pilot cylinder, the shuttle valve, and the spring-return pilot-operated 2-way valve are disposed within the valve body;
the valve spool is moved to a first position when the first pilot cylinder is pressurized and the second pilot cylinder is de-pressurized;
the valve spool is moved to a second position when the second pilot cylinder is pressurized and the first pilot cylinder is de-pressurized;
the valve spool is moved to a third position by the first and second biasing members when the first and second pilot cylinders are de-pressurized;
the outlet port of the shuttle valve supplies pilot pressure to the spring-return pilot-operated 2-way valve;
the spring-return pilot-operated 2-way valve controls fluid communication between the first outlet port and the exhaust port, such that the first outlet port and the exhaust port are not in fluid communication when the spring-return pilot-operated 2-way valve is energized, and the first outlet port and the exhaust port are in fluid communication when the spring-return pilot-operated 2-way valve is de-energized; and
the first normally-depressurized pilot solenoid valve controls pressure to the first pilot cylinder and to the first inlet port of the shuttle valve;
the second normally-depressurized pilot solenoid valve controls pressure to the second pilot cylinder; and
the third pilot solenoid valve controls pressure to the second inlet port of the shuttle valve.

12. The pilot-operated directional-control valve of claim 11, wherein:
the at least four fluid ports also comprise a supply port and a second outlet port;
when the valve spool is in the first position, the supply port and the first outlet port are in fluid communication and the exhaust port and the second outlet port are in fluid communication;
when the valve spool is in the second position, the supply port and the second outlet port are in fluid communication and the exhaust port and the first outlet port are in fluid communication; and
when the valve spool is in the third position, the first outlet port and the second outlet port are in fluid communication and the supply port and the exhaust port are not in fluid communication.

13. A pilot-operated directional-control valve comprising:
a valve body;
at least four fluid ports including a first outlet port and a supply port;
a valve spool;
a first pilot cylinder;
a second pilot cylinder;
a first biasing member;
a second biasing member;
a first normally-depressurized pilot solenoid valve;
a second normally-depressurized pilot solenoid valve;
a third normally-depressurized pilot solenoid valve;
a shuttle valve comprising a first inlet port, a second inlet port, and an outlet port; and
a spring-return pilot-operated 2-way valve, wherein:
the at least four fluid ports, the valve spool, the first pilot cylinder, the second pilot cylinder, the shuttle valve, and the spring-return pilot-operated 2-way valve are disposed within the valve body;
the valve spool is moved to a first position when the first pilot cylinder is pressurized and the second pilot cylinder is de-pressurized;
the valve spool is moved to a second position when the second pilot cylinder is pressurized and the first pilot cylinder is de-pressurized;
the valve spool is moved to a third position by the first and second biasing members when the first and second pilot cylinders are de-pressurized;
the outlet port of the shuttle valve supplies pilot pressure to the spring-return pilot-operated 2-way valve;
the spring-return pilot-operated 2-way valve controls fluid communication between the first outlet port and the supply port, such that the first outlet port and the supply port are not in fluid communication when the spring-return pilot-operated 2-way valve is energized, and the first outlet port and the supply port are in fluid communication when the spring-return pilot-operated 2-way valve is de-energized;
the second normally-depressurized pilot solenoid valve controls pressure to the second pilot cylinder and to the second inlet port of the shuttle valve; and
the third normally-depressurized pilot solenoid valve controls pressure to the first inlet port of the shuttle valve.

14. The pilot-operated directional-control valve of claim 13, wherein:
the at least four fluid ports comprise an exhaust port and a second outlet port;
when the valve spool is in the first position, the supply port and the first outlet port are in fluid communication and the exhaust port and the second outlet port are in fluid communication;
when the valve spool is in the second position, the supply port and the second outlet port are in fluid communication and the exhaust port and the first outlet port are in fluid communication; and
when the valve spool is the third position, the first outlet port and the second outlet port are in fluid communication and the supply port and the exhaust port are not in fluid communication.

15. A pilot-operated directional-control valve comprising:
a valve body;
at least four fluid ports including an exhaust port;
a valve spool;
a first pilot cylinder;
a second pilot cylinder;
a first biasing member;
a second biasing member;
a first normally-depressurized pilot solenoid valve;
a second normally-depressurized pilot solenoid valve;
a third normally-pressurized pilot solenoid valve;
a first 3-way valve comprising a first pilot port and a second pilot port; and
a second 3-way valve comprising a first pilot port and a second pilot port, wherein:
the at least four fluid ports, the valve spool, the first pilot cylinder, the second pilot cylinder, the shuttle valve, the first 3-way valve and the second 3-way valve are disposed within the valve body;
the valve spool is moved to a first position when the first pilot cylinder is pressurized and the second pilot cylinder is de-pressurized;
the valve spool is moved to a second position when the second pilot cylinder is pressurized and the first pilot cylinder is de-pressurized;
the valve spool is moved to a third position by the first and second biasing members when the first and second pilot cylinders are de-pressurized;
the first pilot solenoid valve is configured to control pressure to the first pilot port of the first 3-way valve and the second pilot port of the second 3-way valve;
the second pilot solenoid valve is configured to control pressure to the second pilot port of the first 3-way valve and the first pilot port of the second 3-way valve;
the first 3-way valve is configured to couple the first pilot cylinder to either an outlet of the third normally-pressurized solenoid pilot valve or exhaust; and
the second 3-way valve is configured to couple the second pilot cylinder to either an outlet of the third normally-pressurized solenoid pilot valve or the exhaust port.

16. The pilot-operated directional-control valve of claim 15, wherein:
the at least four fluid ports comprise a supply port, a first outlet port, and a second outlet port;
when the valve spool is in the first position, the supply port and the first outlet port are in fluid communication and the exhaust port and the second outlet port are in fluid communication;
when the valve spool is in the second position, the supply port and the second outlet port are in fluid communication and the exhaust port and the first outlet port are in fluid communication; and
when the valve spool is the third position, the first outlet port and the second outlet port are in fluid communication and the supply port and the exhaust port are not in fluid communication.

17. A pilot-operated directional-control valve comprising:
a valve body;
at least four fluid ports;
a valve spool;
a first pilot cylinder;
a second pilot cylinder;
a first biasing member;
a second biasing member;
a first normally-depressurized pilot solenoid valve;
a second normally-depressurized pilot solenoid valve;
a third normally-depressurized pilot solenoid valve;
a first shuttle valve comprising a first inlet port and a second inlet port;
a second shuttle valve comprising a first inlet port and a second inlet port; and
a single-acting spring return cylinder comprising a piston, wherein:
the at least four fluid ports, the valve spool, the first pilot cylinder, the second pilot cylinder, the first shuttle valve, the second shuttle valve and the single-acting spring return cylinder are disposed within the valve body;
the valve spool is moved to a first position when the first pilot cylinder is pressurized and the second pilot cylinder is de-pressurized;
the valve spool is moved to a second position when the second pilot cylinder is pressurized and the first pilot cylinder is de-pressurized;
the valve spool is moved to a third position by the first and second biasing members when the first and second pilot cylinders are de-pressurized;
the outlet port of the first shuttle valve is configured to supply pressure to the first inlet port of the second shuttle valve;
the outlet port of the second shuttle valve is configured to supply pressure to the single-acting cylinder;
the first normally-depressurized pilot solenoid valve is configured to control pressure to the first pilot cylinder and configured to control pressure to the first inlet port of the first shuttle valve;
the second normally-depressurized pilot solenoid valve is configured to control pressure to the second pilot cylinder and configured to control pressure to the second inlet port of the second shuttle valve;
the third normally-depressurized pilot solenoid valve is configured to control pressure to the second inlet port of the first shuttle valve; and
the spool of the directional-control valve further comprise detents, such that the detents are engaged by the piston of the single-acting cylinder when the single-acting cylinder is energized.

18. The pilot-operated directional-control valve of claim 17, wherein:
the at least four fluid ports comprise a supply port, an exhaust port, a first outlet port, and a second outlet port;
when the valve spool is in the first position, the supply port and the first outlet port are in fluid communication and the exhaust port and the second outlet port are in fluid communication;
when the valve spool is in the second position, the supply port and the second outlet port are in fluid communication and the exhaust port and the first outlet port are in fluid communication; and
when the valve spool is the third position, the first outlet port and the second outlet port are in fluid communication and the supply port and the exhaust port are not in fluid communication.
